(19) United States
(12) Patent Application Publication
(10) Pub. No.: US 2013/0115520 A1
(43) Pub. Date: May 9, 2013

(54) NON-AQUEOUS ELECTROLYTIC SOLUTION, AND ELECTROCHEMICAL ELEMENT UTILIZING SAME

(71) Applicants: Koji Abe, Yamaguchi (JP); Kei Shimamoto, Yamaguchi (JP)

(72) Inventors: Koji Abe, Yamaguchi (JP); Kei Shimamoto, Yamaguchi (JP)

(73) Assignee: UBE INDUSTRIES, LTD., Ube-shi (JP)

(21) Appl. No.: 13/810,457

(22) PCT Filed: Jul. 22, 2011
(86) PCT No.: PCT/JP2011/066755

§ 371 Date: Jan. 16, 2013

(30) Foreign Application Priority Data
Jul. 23, 2010 (JP) 2010-166445
Sep. 10, 2010 (JP) 2010-202759
Dec. 7, 2010 (JP) 2010-273056

(51) Int. Cl. H01M 10/0567; H01M 10/0569; H01M 10/0525; H01G 9/028

(52) U.S. Cl. CPC H01M 10/0567; H01G 9/028; H01M 10/0569; H01M 10/0525
USPC 429/326; 361/527; 429/188; 429/338; 429/343; 429/342; 252/62.2

(57) ABSTRACT

The present invention relates to a nonaqueous electrolytic solution which can improve the electrochemical characteristics in a broad temperature range and an electrochemical element produced by using the same.

Provided are (1) a nonaqueous electrolytic solution prepared by dissolving an electrolyte salt in a nonaqueous solvent, which comprises an organic tin compound represented by the specific formula in an amount of 0.001 to 5% by mass of the nonaqueous electrolytic solution and (2) an electrochemical element comprising a positive electrode, a negative electrode and a nonaqueous electrolytic solution prepared by dissolving an electrolyte salt in a nonaqueous solvent, wherein the above nonaqueous electrolytic solution is the nonaqueous electrolytic solution of (1) described above.

### TECHNICAL FIELD

The present invention relates to a nonaqueous electrolytic solution which can improve the electrochemical characteristics in a broad temperature range and an electrochemical element produced by using the same.

### BACKGROUND ART

In recent years, an electrochemical element, particularly a lithium secondary battery is widely used for electric power storage of small-sized electronic devices, such as cellular phones, notebook-size personal computers and the like and electric vehicles. There is a possibility that the above electronic devices and vehicles are used in a broad temperature range, such as high temperature in the middle of summer and low temperature in a severe cold season, and therefore they are requested to be improved in electrochemical characteristics in a broad temperature range at a good balance.

In particular, it is urgently required to reduce a discharge of CO₂ in order to prevent global warming, and hybrid electric vehicles (HEV), plug-in hybrid electric vehicles (PHEV) and battery electric vehicles (BEV) among environmental response vehicles loaded with electrical storage devices comprising electrochemical elements, such as lithium secondary batteries, capacitors and the like are required to spread in early stages. However, vehicles move at a long distance, and therefore they are likely to be used in regions of a broad temperature range from very hot regions in tropical zones to regions in severe cold zones. Accordingly, the above electrochemical elements for vehicles are required not to be deteriorated in electrochemical characteristics even when they are used in a broad temperature range from high temperature to low temperature.

In the present specification, the term of a lithium secondary battery is used as a concept including as well a so-called lithium ion secondary battery.

Lithium secondary batteries are constituted principally from a positive electrode and a negative electrode containing a material which can absorb and release lithium and a nonaqueous electrolytic solution containing a lithium salt and a nonaqueous solvent, and carbonates, such as ethylene carbonate (EC), propylene carbonate (PC) and the like are used as the nonaqueous solvent.

Also, metal lithium, metal compounds which can absorb and release lithium (metal simple substances, oxides, alloys with lithium and the like) and carbon materials are known as the negative electrode. In particular, lithium secondary batteries produced by using carbon materials, such as cokes, artificial graphites, natural graphites and the like which can absorb and release lithium are widely put into practical use.

In lithium secondary batteries produced by using, for example, highly crystallized carbon materials, such as artificial graphites, natural graphites and the like as negative electrode materials, it is known that decomposed products and gases generated from a solvent in a nonaqueous electrolytic solution which is reduced and decomposed on a surface of a negative electrode in charging the batteries detract from a desired electrochemical reaction of the batteries, so that a cycle property thereof is worsened. Also, when the decomposed products of the nonaqueous solvent are deposited, lithium can not smoothly be absorbed onto and released from a negative electrode, and the electrochemical characteristics thereof are liable to be worsened in a broad temperature range.

Further, in lithium secondary batteries produced by using lithium metal and alloys thereof, metal simple substances, such as tin, silicon and the like and oxides thereof as negative electrode materials, it is known that an initial battery capacity thereof is high but a nonaqueous solvent is acceleratingly reduced and decomposed as compared with a negative electrode of a carbon material since a micronized powdering of the material is promoted during cycles and that battery performances, such as a battery capacity and a cycle property are worsened to a large extent. Also, in a case in which the micronized powdering of the negative electrode material is promoted or the decomposed products of the nonaqueous solvent are deposited, lithium can not smoothly be absorbed onto and released from the negative electrode, and the electrochemical characteristics thereof are liable to be worsened in a broad temperature range.

On the other hand, in lithium secondary batteries produced by using, for example, LiCoO₂, LiMn₂O₄, LiNiO₂, LiFePO₄ and the like as a positive electrode, it is known that decomposed products and gases generated from a solvent in a nonaqueous electrolytic solution which is partially oxidized and decomposed in a local part in an interface between the positive electrode material and the nonaqueous electrolytic solution in a charging state detract from a desired electrochemical reaction of the batteries, so that the electrochemical characteristics thereof are worsened as well in a broad temperature range.

As shown above, decomposed products and gases generated when a nonaqueous electrolytic solution is decomposed on a positive electrode or a negative electrode may interfere with a migration of lithium ions or may swell the battery, and the battery performance is thereby worsened. In spite of the above situations, electronic equipments in which lithium secondary batteries are mounted are advanced more and more in multi-functionalization and tend to be increased in an electric power consumption. As a result thereof, lithium secondary batteries are advanced more- and more in an elevation of a capacity, and a nonaqueous electrolytic solution is reduced in a volume thereof occupied in the battery, wherein the electrode is increased in a density, and a useless space volume in the battery is reduced. Accordingly, observed is a situation in which the electrochemical characteristics thereof in a broad temperature range are liable to be worsened by decomposition of only a small amount of the nonaqueous electrolytic solution.

A nonaqueous electrolytic solution containing a specific organic tin compound is proposed in a patent document 1, and it is suggested that the cycle property at 60° C. and the like are improved by using the electrolytic solution prepared by adding, for example, dibutyltin (1-allyloxymethyl)ethylene glycolate and dibutyltin bis(acetylacetonate).

It is shown in a patent document 2 that when a tin compound having a specific structure (combination of tin (II) bis(acetylacetonate) and tetrabutyltin, etc.) is contained in a nonaqueous electrolytic solution, the cycle property at 25° C. and the charging storage property at 60° C. are improved.

### CITATION LIST

### Patent Documents

Patent document 1: JP-A 2003-173816
Patent document 2: WO 2007/023700

### SUMMARY OF THE INVENTION

### Problems that the Invention is to Solve

An object of the present invention is to provide a nonaqueous electrolytic solution which can improve the electrochemical characteristics in a broad temperature range and an electrochemical element produced by using the same.

### Means for Solving the Problems

The present inventors have investigated in detail the performances of the nonaqueous electrolytic solutions in the conventional techniques described above. As a result thereof, the existing situation is that in the nonaqueous electrolytic solutions of the patent documents described above, a subject of improving the electrochemical characteristics in a broad temperature range, such as the cycle property at low temperature, the low-temperature discharging property after stored at high temperature and the like can not necessarily be sufficiently satisfied.

Accordingly, the present inventors have repeated intensive researches in order to solve the problems described above and found that the electrochemical characteristics in a broad temperature range, particularly the electrochemical characteristics of lithium batteries can be improved by adding 0.001 to 5% by mass of a specific organic tin compound to a nonaqueous electrolytic solution prepared by dissolving an electrolyte salt in a nonaqueous solvent, and thus they have completed the present invention.

That is, the present invention provides the following items (1) and (2).

(1) A nonaqueous electrolytic solution prepared by dissolving an electrolyte salt in a nonaqueous solvent, which comprises at least one organic tin compound represented by any one of the following Formulas (I) to (IV) in an amount of 0.001 to 5% by mass of the nonaqueous electrolytic solution:

[Formula 1]

SnR¹R²R³R⁴ (I)

(wherein R¹ represents an alkyl group having 1 to 8 carbon atoms, an alkenyl group having 2 to 8 carbon atoms or an alkynyl group having 2 to 8 carbon atoms; R² to R⁴ each represent independently an alkyl group having 1 to 8 carbon atoms, an alkenyl group having 2 to 8 carbon atoms, an alkynyl group having 2 to 8 carbon atoms or an aryl group having 6 to 12 carbon atoms; and hydrogen atoms of R¹ to R⁴ may be substituted with fluorine atoms);

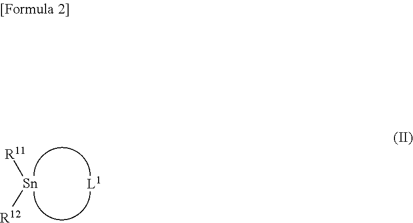

(wherein R¹¹ and R¹² each represent independently an alkyl group having 1 to 8 carbon atoms, an alkenyl group having 2 to 8 carbon atoms, an alkynyl group having 2 to 8 carbon atoms or an aryl group having 6 to 12 carbon atoms; L¹ represents an alkylene group having 2 to 10 carbon atoms or an alkenylene group having 4 to 10 carbon atoms; R¹¹ and R¹² may bond to each other to form a ring; and hydrogen atoms of R¹¹, R¹² and L¹ may be substituted with fluorine atoms);

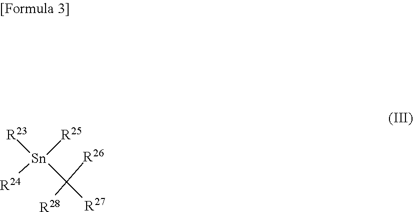

(wherein R²³ to R²⁵ each represent independently an alkyl group having 1 to 8 carbon atoms, a cycloalkyl group having 3 to 8 carbon atoms, an alkenyl group having 2 to 8 carbon atoms, an alkynyl group having 2 to 8 carbon atoms or an aryl group having 6 to 12 carbon atoms; R²⁶ and R²⁷ each represent independently an alkyl group having 1 to 6 carbon atoms, an alkenyl group having 2 to 6 carbon atoms or an alkynyl group having 2 to 6 carbon atoms; R²⁶ and R²⁷ may bond to each other to form a ring; R²⁸ represents a hydrogen atom, an alkyl group having 1 to 6 carbon atoms, an alkenyl group having 2 to 6 carbon atoms or an alkynyl group having 2 to 6 carbon atoms; and hydrogen atoms of R²³ to R²⁸ may be substituted with fluorine atoms);

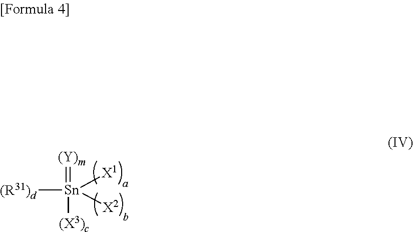

(wherein X¹, X² and X³ each represent independently the following substituents containing an oxygen atom or a sulfur atom:

—OSO₂R³² —OC(O)R³² —OR³² —SR³² —S-L³-OC(O)OR³² —OC(R³²)═CHC(O)R³² —OC(R³³)═CHC(O)R³² [Formula 5]

X¹ and X² may bond to each other to form the following substituents:

—O-L³-O— —S-L³-S— —S-L³-O— —S-L³-C(O)O— [Formula 6]

R³¹ represents an alkyl group having 1 to 8 carbon atoms, an alkenyl group having 2 to 8 carbon atoms, an alkynyl group having 2 to 8 carbon atoms or an aryl group having 6 to 12 carbon atoms; R³² and R³³ represent an alkyl group having 1 to 8 carbon atoms or an aryl group having 6 to 12 carbon atoms; Y represents an oxygen atom or a sulfur atom; L represents an alkylene group having 1 to 8 carbon atoms which may have an ether bond or a carbon-carbon unsaturated bond; hydrogen atoms of R³¹, R³², R³³ and L³ may be substituted with fluorine atoms; a, b and c represent 0 or 1; d represents an integer of 1 to 3, and m represents 0 or 1; when m is 0, a+b+c+d=4; and when m is 1, a=b=c=0, and d=2).
(2) An electrochemical element comprising a positive electrode, a negative electrode and a nonaqueous electrolytic solution prepared by dissolving an electrolyte salt in a nonaqueous solvent, wherein the above nonaqueous electrolytic solution is the nonaqueous electrolytic solution according to the item (1) described above.

### ADVANTAGE OF THE INVENTION

According to the present invention, capable of being provided are a nonaqueous electrolytic solution which can improve the electrochemical characteristics in a broad temperature range, particularly the cycle property at low temperature and the low-temperature discharging property after stored at high temperature and an electrochemical element, such as a lithium battery and the like produced by using the above nonaqueous electrolytic solution.

### MODE FOR CARRYING OUT THE INVENTION

The present invention relates to a nonaqueous electrolytic solution and an electrochemical element produced by using the same.

The nonaqueous electrolytic solution of the present invention is characterized by that 0.001 to 5% by mass of at least one organic tin compound represented by any one of Formulas (I) to (IV) described above is contained in the nonaqueous electrolytic solution, and to be more specific, it is preferably the nonaqueous electrolytic solutions of the following embodiments (1) to (3).

(1) A nonaqueous electrolytic solution prepared by dissolving an electrolyte salt in a nonaqueous solvent, wherein the above nonaqueous solvent contains linear carbonate and cyclic carbonate; the above linear carbonate contains at least both of symmetric linear carbonate and asymmetric linear carbonate; a content of the symmetric linear carbonate is larger than that of the asymmetric linear carbonate; and 0.001 to 5% by mass of the organic tin compound represented by the following Formula (I) is contained in the nonaqueous electrolytic solution (hereinafter referred to as the invention I):

[Formula 7]

SnR¹R²R³R⁴ (I)

(wherein R¹ to R⁴ are the same as described above).
(2) A nonaqueous electrolytic solution prepared by dissolving an electrolyte salt in a nonaqueous solvent, which comprises the organic tin compound represented by the following Formula (II) and/or (III) in an amount of 0.001 to 5% by mass of the nonaqueous electrolytic solution (hereinafter referred to as the invention II):

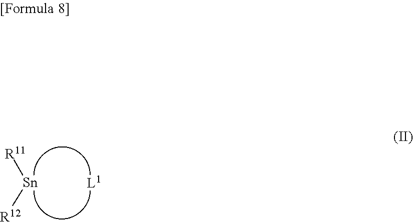

(wherein R¹¹, R¹² and L¹ are the same as described above) and

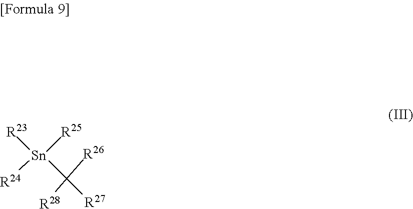

(wherein R²³ to R²⁸ are the same as described above).
(3) A nonaqueous electrolytic solution prepared by dissolving an electrolyte salt in a nonaqueous solvent, wherein the above nonaqueous solvent contains cyclic carbonate and linear ester; the cyclic carbonate contains at least cyclic carbonate having a fluorine atom or a carbon-carbon double bond; and 0.001 to 5% by mass of the organic tin compound represented by the following Formula (IV) is contained in the nonaqueous electrolytic solution (hereinafter referred to as the invention III):

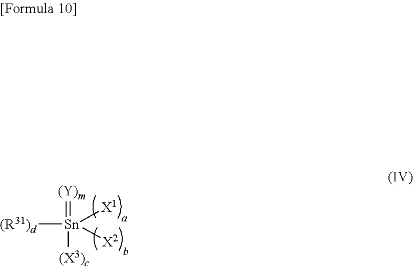

(wherein X¹, X², X³, Y and R³¹ are the same as described above).

### Invention I:

A reason why the nonaqueous electrolytic solution of the invention I can improve the electrochemical characteristics in a broad temperature range to a large extent is not necessarily clear, but it is estimated as follows.

The organic tin compound represented by Formula (I) described above which is contained in the nonaqueous electrolytic solution of the invention I has four substituents on a tin element, wherein at least one of them is an aliphatic substituent, and the remaining three substituents are aliphatic or aromatic hydrocarbon substituents. Further, both linear carbonates of symmetric linear carbonate which works for improving a heat resistance of the coating film and asymmetric linear carbonate which prevents the coating film from being too much minutely deposited are contained in the nonaqueous electrolytic solution. It is considered to be due to that particularly when more asymmetric linear carbonate is contained, the coating film derived from the organic tin compound described above and the coating film derived from the linear carbonate are combined into a coating film which has a further higher heat resistance and which is excellent in a discharging performance at low temperature. It has been found that because of the above reason, a specific effect of notably improving the electrochemical characteristics in a broad temperature range from low temperature to high temperature is brought about.

The organic tin compound contained in the nonaqueous electrolytic solution of the invention I is represented by the following Formula (I):

[Formula 11]

SnR¹R²R³R⁴ (I)

R¹ in Formula (I) described above represents a linear or branched alkyl group having 1 to 8 carbon atoms, a linear or branched alkenyl group having 2 to 8 carbon atoms or a linear or branched alkynyl group having 2 to 8 carbon atoms, and it is more preferably a linear or branched alkyl group having 4 to 8 carbon atoms or a linear or branched alkenyl group having 3 to 8 carbon atoms, particularly preferably a linear or branched alkyl group having 5 to 8 carbon atoms.

Also, R² to R⁴ each represent independently a linear or branched alkyl group having 1 to 8 carbon atoms, a linear or branched alkenyl group having 2 to 8 carbon atoms, a linear or branched alkynyl group having 2 to 8 carbon atoms or an aryl group having 6 to 12 carbon atoms, and it is more preferably a linear or branched alkyl group having 4 to 8 carbon atoms or a linear or branched alkenyl group having 3 to 8 carbon atoms, particularly preferably a linear or branched alkyl group having 5 to 8 carbon-atoms.

In this regard, hydrogen atoms of R¹ to R⁴ may be substituted with fluorine atoms. Also, any substituents in the groups of R¹ and R² to R⁴ are more preferably different.

The specific examples of R¹ suitably include (i) linear alkyl groups, such as a methyl group, an ethyl group, a n-propyl group, a n-butyl group, a n-pentyl group, a n-hexyl group, a n-heptyl group, a n-octyl group and the like, branched alkyl groups, such as an iso-propyl group, a sec-butyl group, a tert-butyl group, a tert-amyl group and the like, alkyl groups in which a part of hydrogen atoms is substituted with fluorine, such as a fluoromethyl group, a trifluoromethyl group, a 2,2,2-trifluoroethyl group and the like, (ii) linear alkenyl groups, such as a vinyl group, a 2-propene-1-yl group, a 2-butene-1-yl group, a 3-butene-1-yl group, a 4-pentene-1-yl group, a 5-hexene-1-yl group and the like, or branched alkenyl groups, such as a 2-methyl-1-propene-1-yl group, a 2-methyl-2-propene-1-yl group, a 3-butene-2-yl group, a 3-pentyne-2-yl group, a 2-methyl-3-butene-2-yl group, a 3-methyl-2-butene-1-yl group and the like, (iii) linear alkynyl groups, such as a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyne-2-yl group, a 2-methyl-3-butyne-2-yl group and the like. Among them, a n-butyl group, a n-pentyl group, a n-hexyl group, a n-heptyl group, a n-octyl group and a 2-propene-1-yl group are further preferred, and a n-pentyl group, a n-hexyl group, a n-heptyl group and a n-octyl group are particularly preferred.

The specific examples of R² to R⁴ suitably include (i) linear alkyl groups, such as a methyl group, an ethyl group, a n-propyl group, a n-butyl group, a n-pentyl group, a n-hexyl group, a n-heptyl group, a n-octyl group and the like, branched alkyl groups, such as an iso-propyl group, a sec-butyl group, a tert-butyl group, a tert-amyl group and the like, alkyl groups in which a part of hydrogen atoms is substituted with fluorine, such as a fluoromethyl group, a trifluoromethyl group, a 2,2,2-trifluoroethyl group and the like, (ii) linear alkenyl groups, such as a vinyl group, a 2-propene-1-yl group, a 2-butene-1-yl group, a 3-butene-1-yl group, a 4-pentene-1-yl group, a 5-hexene-1-yl group and the like, or branched alkenyl groups, such as a 3-butene-2-yl group, a 2-methyl-1-propene-1-yl group, a 2-methyl-2-propene-1-yl group, a 3-pentyne-2-yl group, a 2-methyl-3-butene-2-yl group, a 3-methyl-2-butene-1-yl group and the like, (iii) linear alkynyl groups, such as a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyne-2-yl group, a 2-methyl-3-butyne-2-yl group and the like and (iv) aryl groups, such as a phenyl group, a 2-methylphenyl group, a 3-methylphenyl group, a 4-methylphenyl group, a 4-tert-butylphenyl group, a 4-methoxyphenyl group, a 2,4,6-trimethylphenyl group, a 2-fluorophenyl group, a 3-fluorophenyl group, a 4-fluorophenyl group, a 2,4-difluorophenyl group, a 2,6-difluorophenyl group, a 3,4-difluorophenyl group, a 2,4,6-trifluorophenyl group; a pentafluorophenyl group, a 4-trifluoromethylphenyl group and the like. Among them, a n-butyl group, a n-pentyl group, a n-hexyl group, a n-heptyl group, a n-octyl group and a 2-propene-1-yl group are preferred, and a n-pentyl group, a n-hexyl group, a n-heptyl group and a n-octyl group are further preferred.

The specific examples of the organic tin compound represented by Formula (I) described above suitably include tetramethyltin, tetraethyltin, tetrapropyltin, tetra(propane-2-yl)tin, tetrabutyltin, tetra(2-methylpropane-1-yl)tin, tetra(butane-2-yl)tin, tetrapentyltin, tetrahexyltin, tetraheptyltin, tetraoctyltin, tetracyclohexyltin, tetravinyltin, tetra(2-propene-1-yl)tin, trimethylvinyltin, trimethyl(2-propene-1-yl)tin, tributylmethyltin, tributyl(2-methylpropane-2-yl)tin, tributyl(2-methylbutane-2-yl)tin, tributylvinyltin, tributyl(2-propene-1-yl)tin, (2-butene-1-yl)tributyltin, (3-butene-1-yl)tributyltin, tributyl(4-pentene-1-yl)tin, tributyl(5-hexene-1-yl)tin, tributyl(2-methyl-1-propene-1-yl)tin, tributyl(2-methyl-2-propene-1-yl)tin, tributyl(3-butene-2-yl)tin, tributyl(3-pentene-2-yl)tin, tributyl(3-methyl-2-butene-1-yl)tin, tributyl(2-methyl-3-butene-2-yl)tin, tributyl(2-propyne-1-yl)tin, tributyl(2-butyne-1-yl)tin, tributyl(3-butyne-1-yl)tin, tributyl(4-pentyne-1-yl)tin, tributyl(5-hexyne-1-yl)tin, tributyl(3-butyne-2-yl)tin, tributyl(3-pentyne-2-yl)tin, tributyl(2-methyl-3-butyne-2-yl)tin, trimethylphenyltin, tributylphenyltin, tributyl(4-methylphenyl)tin, tributyl(4-methoxyphenyl)tin, tributyl(4-fluorophenyl)tin, tributyl(2,6-difluorophenyl)tin, tributyl(2,3,4,5,6-pentafluorophenyl)tin, tributyl(4-trifluoromethylphenyl)tin, tributyl(fluoromethyl)tin, trifluoromethyltrimethyltin, tributyl(trifluoromethyl)tin, tributyl(2,2,2-trifluoroethyl)tin, dibutyldimethyltin, dibutyldicyclohexyltin, dibutyldivinyltin, dibutyldi(2-propene-1-yl)tin, dibutyldi(2-propyne-1-yl)tin, dimethyldiphenyltin and dibutyldiphenyltin.

Among them, tetrabutyltin, tetrapentyltin, tetrahexyltin, tetraheptyltin, tetraoctyltin, tetra(2-propene-1-yl)tin, tributyl(2-propene-1-yl)tin and dibutyldi(2-propene-1-yl)tin are more preferred, and tetrapentyltin, tetrahexyltin, tetraheptyltin, tetraoctyltin and tributyl(2-propene-1-yl)tin are further preferred. Tetrapentyltin, tetrahexyltin, tetraheptyltin and tetraoctyltin are particularly preferred.

When the substituents of R¹ to R⁴ fall in the ranges described above, the electrochemical characteristics in a broad temperature range can be improved to a large extent, and therefore they are preferred.

In the nonaqueous electrolytic solution of the present invention, a content of the organic tin compound represented by Formula (I) described above which is contained in the nonaqueous electrolytic solution is preferably 0.001 to 5% by mass in the nonaqueous electrolytic solution. If the above content is 5% by mass or less, the coating film is less likely to be formed in excess on the electrode and worsened in low-temperature properties. On the other hand, if it is 0.001% by mass or more, the coating film is formed sufficiently well and enhanced in an effect of improving a high-temperature storage property. The above content is preferably 0.01% by mass or more, more preferably 0.03% by mass or more and further preferably 0.05% by mass or more in the nonaqueous electrolytic solution, and an upper limit thereof is preferably 1% by mass or less, more preferably 0.4% by mass or less, further preferably 0.2% by mass or less and particularly preferably 0.1% by mass or less.

In the nonaqueous electrolytic solution of the present invention, a specific effect of synergistically improving the electrochemical characteristics in a broad temperature range is exerted by combining the organic tin compound represented by Formula (I) with a nonaqueous solvent, an electrolyte salt and other additives which are described below.

### Invention II:

A reason why the nonaqueous electrolytic solution of the invention II can improve the electrochemical characteristics in a broad temperature range to a large extent is not necessarily clear, but it is estimated as follows.

The organic tin compound represented by Formula (II) and/or (III) described above which is contained in the nonaqueous electrolytic solution of the invention II has four substituents on a tin element, and at least two of them are aliphatic substituents and have a structure in which they bond to each other to form a ring (formula (II)), or at least one substituent of them has carbon bonded to a tin element and further has two aliphatic substituents on the above carbon (formula (III)). The coating film which has a high heat resistance and is excellent in a discharging performance at low temperature due to a high heat resistance originating in a tin element and a steric effect exerted by a bulky substituent having a cyclic structure or a branched structure is considered to be formed by containing the organic tin compound having the above specific structure in the nonaqueous electrolytic solution. It has been found that because of the above reasons, a specific effect of notably improving the electrochemical characteristics in a broad temperature range from low temperature to high temperature is brought about.

The organic tin compound contained in the nonaqueous electrolytic solution of the invention II is represented by the following Formula (II) and/or (III):

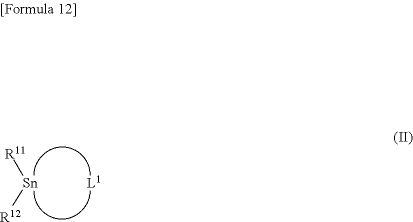

(wherein R¹¹, R¹² and L¹ are the same as described above) and

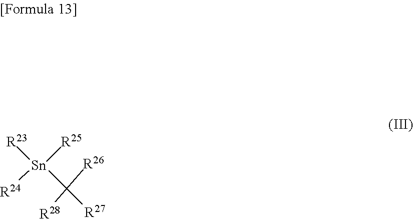

(wherein R²³ to R²⁸ are the same as described above).

R¹¹ and R¹² in Formula (II) described above each represent independently a linear or branched alkyl group having 1 to 8 carbon'atoms, a linear or branched alkenyl group having 2 to 8 carbon atoms, a linear or branched alkynyl group having 2 to 8 carbon atoms or an aryl group having 6 to 12 carbon atoms, and they are more preferably a linear or branched alkyl group having 4 to 0.8 carbon atoms or a linear or branched alkenyl group having 3 to 8 carbon atoms, further preferably a linear or branched alkyl group having 5 to 8 carbon atoms or a linear or branched alkenyl group having 3 to 6 carbon atoms.

Also, R¹¹ and R¹² are a linear or branched alkyl group having 1 to 8 carbon atoms and may bond to each other to form a ring, and in this case, a linkage chain for forming the preferred ring is the same as in L¹.

L¹ represents a linear or branched alkylene group having 2 to 10 carbon atoms or a linear or branched alkenylene group having 4 to 10 carbon atoms, and it is more preferably a linear or branched alkylene group having 4 to 8 carbon atoms or a linear or branched alkylene group having 4 to 8 carbon atoms, further preferably a linear alkylene group having 4 to 6 carbon atoms.

Hydrogen atoms of R¹¹, R¹² and L¹ may be substituted with fluorine atoms.

The specific examples of R¹¹ to R¹² suitably include (1) linear alkyl groups, such as a methyl group, an ethyl group, a n-propyl group, a n-butyl group, a n-pentyl group, a n-hexyl group, a n-heptyl group, a n-octyl group and the like, branched alkyl groups, such as an iso-propyl group, a sec-butyl group, a tert-butyl group, a tert-amyl group and the like, alkyl groups in which a part of hydrogen atoms is substituted with fluorine, such as a fluoromethyl group, a trifluoromethyl group, a 2,2,2-trifluoroethyl group and the like, (ii) linear alkenyl groups, such as a vinyl group, a 2-propene-1-yl group, a 2-butene-1-yl group, a 3-butene-1-yl group, a 4-pentene-1-yl group, a 5-hexene-1-yl group and the like, or branched alkenyl groups, such as a 3-butene-2-yl group, a 2-methyl-1-propene-1-yl group, a 2-methyl-2-propene-1-yl group, a 3-pentene-2-yl group, a 2-methyl-3-butene-2-yl group, a 3-methyl-2-butene-1-yl group and the like, (iii) linear alkynyl groups, such as an ethynyl group, a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyne-2-yl group, a 2-methyl-3-butyne-2-yl group and the like and (iv) aryl groups, such as a phenyl group, a 2-methylphenyl group, a 3-methylphenyl group, a 4-methylphenyl group, a 4-tert-butylphenyl group, a 4-methoxyphenyl group, a 2,4,6-trimethylphenyl group, a 2-fluorophenyl group, a 3-fluorophenyl group, a 4-fluorophenyl group, a 2,4-difluorophenyl group, a 2,6-difluorophenyl group, a 3,4-difluorophenyl group, a 2,4,6-trifluorophenyl group, a pentafluorophenyl group, a 4-trifluoromethylphenyl group and the like. Among them, a n-butyl group, a n-pentyl group, a n-hexyl group, a n-heptyl group, a n-octyl group and a 2-propene-1-yl group are preferred, and a n-pentyl group, a n-hexyl group, a n-heptyl group, a n-octyl group and a 2-propene-1-yl group are more preferred.

The specific examples of a case in which R¹¹ and R¹² are a linear or branched alkyl group having 1 to 8 carbon atoms and bond to each other to form a ring suitably include an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group and the like. Among them, a butane-1,4-diyl group, a pentane-1,5-diyl group, a hexane-1,6-diyl group, a heptane-1,7-diyl group and an octane-1,8-diyl group 1 are preferred, and a butane-1,4-diyl group, a pentane-1,5-diyl group and a hexane-1,6-diyl group are further preferred.

The specific examples of L¹ suitably include an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group and the like. Among them, a butane-1,4-diyl group, a pentane-1,5-diyl group, a hexane-1,6-diyl group, a heptane-1,7-diyl group and an octane-1,8-diyl group 1 are preferred, and a butane-1,4-diyl group, a pentane-1,5-diyl group and a hexane-1,6-diyl group are further preferred.

The specific examples of the organic tin compound represented by Formula (II) described above suitably include 1,1-dimethyl-1-stannacyclopropane, 1,1-dibutyl-1-stannacyclopropane, 1,1-dipentyl-1-stannacyclopropane, 1,1-di(2-propene-1-yl)-1-stannacyclopropane, 1,1-dimethyl-1-stannacyclobutane, 1,1-dibutyl-1-stannacyclobutane, 1,1-dipentyl-1-stannacyclobutane, 1,1-di(2-propene-1-yl)-1-stannacyclobutane, 1,1-dimethyl-1-stannacyclopentane, 1,1-diethyl-1-stannacyclopentane, 1-butyl-1-methyl-1-stannacyclopentane, 1,1-dibutyl-1-stannacyclopentane, 1,1-dipentyl-1-stannacyclopentane, 1,1-di(2-propene-1-yl)-1-stannacyclopentane, 1,1-dimethyl-1-stannacyclohexane, 1,1-diethyl-1-stannacyclohexane, 1-butyl-1-methyl-1-stannacyclohexane, 1,1-dibutyl-1-stannacyclohexane, 1,1-dipentyl-1-stannacyclohexane, 1,1-di(2-propene-1-yl)-1-stannacyclohexane, 1,1,4,4-tetramethyl-1-stannacyclohexane, 1,1-dibutyl-4,4-dimethyl-1-stannacyclohexane, 1,1-dimethyl-1-stannacycloheptane, 1,1-dibutyl-1-stannacycloheptane, 1,1-dipentyl-1-stannacycloheptane, 1,1-di(2-propene-1-yl)-1-stannacycloheptane, 1,1-dimethyl-1-stannacyclooctane, 1,1-dibutyl-1-stannacyclooctane, 1,1-dipentyl-1-stannacyclooctane, 1,1-di(2-propene-1-yl)-1-stannacyclooctane, 5-stannaspiro[4,4]nonane: 5-stannaspiro[4,5]decane, 6-stannaspiro[5,5]undecane, 3,3,9,8-tetramethyl-6-stannaspiro[5,5]undecane and 7-stannaspiro[6,6]tridecane.

Among the compounds described above, more preferred are 1,1-dibutyl-1-stannacyclopentane, 1,1-dipentyl-1-stannacyclopentane, 1,1-di(2-propene-1-yl)-1-stannacyclopentane, 1,1-dibutyl-1-stannacyclohexane, 1,1-dipentyl-1-stannacyclohexane, 1,1-di(2-propene-1-yl)-1-stannacyclohexane, 1,1-dibutyl-1-stannacycloheptane, 1,1-dipentyl-1-stannacycloheptane, 1,1-di(2-propene-1-yl)-1-stannacycloheptane, 6-stannaspiro[5,5]undecane and 7-stannaspiro[6,6]tridecane.

R²³ to R²⁵ in Formula (III) described above each represent independently a linear or branched alkyl group having 1 to 8 carbon atoms, a cycloalkyl group having 3 to 8 carbon atoms, a linear or branched alkenyl group having 2 to 8 carbon atoms, a linear or branched alkynyl group having 2 to 8 carbon atoms or an aryl group having 6 to 12 carbon atoms, and they are more preferably a linear or branched alkyl group having 3 to 8 carbon atoms, a cycloalkyl group having 5 to 7 carbon atoms or a linear or branched alkenyl group having 3 to 8 carbon atoms, further preferably a branched alkyl group having 3 to 8 carbon atoms or a cycloalkyl group having 5 to 7 carbon atoms. At least one of R²³ to R²⁵ is preferably a branched alkyl group having 3 to 8 carbon atoms or a cycloalkyl group having 5 to 7 carbon atoms, and two or more of them are further preferably a branched alkyl group having 3 to 8 carbon atoms or a cycloalkyl group having 5 to 7 carbon atoms.

R²⁶ and R²⁷ each represent independently a linear or branched alkyl group having 1 to 6 carbon atoms, a linear or branched alkenyl group having 2 to 6 carbon atoms or a linear or branched alkynyl group having 2 to 6 carbon atoms, and they are more preferably a linear or branched alkyl group having 1 to 4 carbon atoms or a linear or branched alkenyl group having 2 to 4 carbon atoms. R²⁶ and R²⁷ bond more preferably to each other to form a ring, and in this case, the ring constituted has more preferably 3 to 9 carbon atoms, further preferably 4 to 6 carbon atoms.

R²⁸ represents a hydrogen atom, a linear or branched alkyl group having 1 to 6 carbon atoms, a linear or branched alkenyl group having 2 to 6 carbon atoms or a linear or branched alkynyl group having 2 to 6 carbon atoms, and it is preferably a hydrogen atom, a linear or branched alkyl group having 1 to 4 carbon atoms or a linear or branched alkenyl group having 2 to 4 carbon atoms.

Hydrogen atoms of R²³ to R²⁸ may be substituted with fluorine atoms.

The specific examples of R²³ to R²⁵ in Formula (III) described above suitably include (i) linear alkyl groups, such as a methyl group, an ethyl group, a n-propyl group, a n-butyl group, a n-pentyl group, a n-hexyl group, a n-heptyl group, a n-octyl group and the like, branched alkyl groups, such as an iso-propyl group, a sec-butyl group, a tert-butyl group, a tert-amyl group and the like, alkyl groups in which a part of hydrogen atoms is substituted with a fluorine atom, such as a fluoromethyl group, a trifluoromethyl group, a 2,2,2-trifluoroethyl group and the like, (ii) linear alkenyl groups, such as a vinyl group, a 2-propene-1-yl group, a 2-butene-1-yl group, a 3-butene-1-yl group, a 4-pentene-1-yl group, a 5-hexene-1-yl group and the like, or branched alkenyl groups, such as a 3-butene-2-yl group, a 2-methyl-1-propene-1-yl group, a 2-methyl-2-propene-1-yl group, a 3-pentene-2-yl group, a 2-methyl-3-butene-2-yl group, a 3-mthyl-2-butene-1-yl group and the like, (iii) linear alkynyl groups, such as an ethynyl group, a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyn-2-yl group, a 2-methyl-3-butyne-2-yl group and the like and (iv) cycloalkyl groups, such as a cyclopropyl group, a cyclobutyl group, a cyclopentyl group, a cyclohexyl group, a cycloheptyl group, a cyclooctyl group and the like. Among them, a n-butyl group, a n-pentyl group, a n-hexyl group, a vinyl group, a 2-propene-1-yl group, a 2-propyne-1-yl group, an iso-propyl group, a sec-butyl group, a tert-butyl group, a tert-amyl group, a cyclopentyl group, a cyclohexyl group and a cycloheptyl group are preferred, and an iso-propyl group, a tert-butyl group, a Cert-amyl group, a cyclopentyl group and a cyclohexyl group are further preferred.

The specific examples of R²⁶ and R²⁷ suitably include (i) linear alkyl groups, such as a methyl group, an ethyl group, a n-propyl group, a n-butyl group, a n-pentyl group, a n-hexyl group and the like, branched alkyl groups, such as an iso-propyl group, a sec-butyl group, a tert-butyl group, a tert-amyl group and the like, alkyl groups in which a part of hydrogen atoms is substituted with a fluorine atom, such as a fluoromethyl group, a trifluoromethyl group, a 2,2,2-trifluoroethyl group and the like, (ii) linear alkenyl groups, such as a vinyl group, a 2-propene-1-yl group, a 2-butene-1-yl group, a 3-butene-1-yl group, a 4-pentene-1-yl group, a 5-hexene-1-yl group and the like, or branched alkenyl groups, such as a 3-butene-2-yl group, a 2-methyl-1-propene-1-yl group, a 2-methyl-2-propene-1-yl group, a 3-pentene-2-yl group, methyl-3-butene-2-yl group, a 3-methyl-2-butene-1-yl group and the like, (iii) linear alkynyl groups, such as an ethynyl group, a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyne-2-yl group, a 2-methyl-3-butyne-2-yl group and the like. Among them, a methyl group, an ethyl group, a n-propyl group, an iso-propyl group, a vinyl group, a 2-propene-1-yl group, an ethynyl group and a 2-propyne-1-yl group are preferred, and a methyl group, an ethyl group and a vinyl group are further preferred.

The specific examples of R²⁸ are the same as those of R²⁶ and R²⁷, except that it may be a hydrogen atom, and it is preferably a hydrogen atom, a methyl group, an ethyl group, a n-propyl group, an iso-propyl group, a vinyl group, a 2-propene-1-yl group, an ethynyl and a 2-propyne-1-yl group, further, preferably a hydrogen atom, a methyl group and an ethyl group.

R²⁶ and R²⁷ bond more preferably to each other to form a ring, and the specific examples of a substituent (—CR²⁶R²⁷R²⁸) bonded to an Sn atom suitably include cycloalkyl groups, such as a cyclopropyl group, a cyclobutyl group, a cyclopentyl group, a cyclohexyl group, a cycloheptyl group, a cyclooctyl group and the like. A cyclopentyl group, a cyclohexyl group and a cycloheptyl group are further preferred.

The specific examples of the organic tin compound represented by Formula (I) described above suitably include trimethyl(iso-propyl)tin, (sec-butyl)trimethyltin, (tert-butyl)trimethyltin, (tert-amyl)trimethyltin, tributyl(iso-propyl)tin, tributyl(sec-butyl)tin, tributyl(tert-butyl)tin, (tert-amyl)tributyltin, tripentyl(iso-propyl)tin, (sec-butyl)tripentyltin, (tert-butyl)tripentyltin, (tert-amyl)tripentyltin, trihexyl(iso-propyl)tin, (sec-butyl)trihexyltin, (tert-butyl)trihexyltin, (tert-amyl)trihexyltin, trioctyl(iso-propyl)tin, (sec-butyl)trioctyltin, (tert-butyl)trioctyltin, (tert-amyl)trioctyltin, dimethyldi(iso-propyl)tin, di(sec-butyl)dimethyltin, di(tert-butyl)dimethyltin, di(tert-amyl)dimethyltin, dibutyldi(iso-propyl)tin, dibutyldi(sec-butyl)tin, dibutyldi(tert-butyl)tin, di(tert-amyl)dibutyltin, dipentyldi(iso-propyl)tin, di(sec-butyl)dipentyltin, di(tert-butyl)dipentyltin, di(tert-amyl)dipentyltin, dihexyldi(iso-propyl)tin, di(sec-butyl)dihexyltin, di(tert-butyl)dihexyltin, di(tert-amyl)dihexyltin, dioctyldi(iso-propyl)tin, di(sec-butyl)dioctyltin, di(tert-butyl)dioctyltin, di(tert-amyl)dioctyltin, tetra(iso-propyl)tin, tetra(sec-butyl)tin, cyclopropyltrimethyltin, tributyl(cyclopropyl)tin, cyclopropyltripentyltin, cyclppropyltrihexyltin, cyclopropyltrioctyltin, cyclobutyltrimethyltin, tributyl(cyclobutyl)tin, cyclobutyltripentyltin, cyclobutyltrihexyltin, cyclobutyltrioctyltin, cyclopentyltrimethyltin, tributyl(cyclopentyl)tin, cyclopentyltripentyltin, cyclopentyltrihexyltin, cyclopentyltrioctyltin, cyclohexyltrimethyltin, tributyl(cyclohexyl)tin, cyclohexyltripentyltin, cyclohexyltrihexyltin, cyclohexyltrioctyltin, cycloheptyltrimethyltin, tributyl(cycloheptyl)tin, cycloheptyltripentyltin, cycloheptyltrihexyltin, cycloheptyltrioctyltin, cyclooctyltrimethyltin, tributyl(cyclooctyl)tin, cyclooctyltripentyltin, cyclooctyltrihexyltini, cyclooctyltrioctyltin, di(cyclopentyl)dimethyltin, dibutyldi(cyclopentyl)tin, di(cyclopentyl)dipentyltin, di(cyclopentyl)dihexyltin, di(cyclopentyl)dioctyltin, di(cyclohexyl)dimethyltin, dibutylai(cyclohexyl)tin, di(cyclohexyl)dipentytin, di(cyclohexyl)dihexyltin, di(cyclohexyl)dioctyltin, tri(cyclopentyl)methyltin, butyltri(cyclopentyl)tin, tri(cyclopentyl)pentyltin, tri(cyclopentyl)hexyltin, tri(cyclopentyl)octyltin, tri(cyclohexyl)methyltin, butyltri(cyclohexyl)tin, tri(cyclohexyl)pentyltin, tri(cyclohexyl)hexyltin, tri(cyclohexyl)octyltin, tetracyclopentyltin and tetracyclohexyltin.

Among the compounds described above, more preferred are dibutyldi(iso-propyl)tin, dibutyldi(sec-butyl)tin, dibutylai(tert-butyl)tin, dipentyldi(iso-propyl)tin, di(sec-butyl)dipentyltin, di(tert-butyl)dipentyltin, tributyl(cyclopentyl)tin, cyclopenyltripentyltin, tributyl(cyclohexyl)tin, cyclohexyltripentyltin, tributyl(cycloheptyl)tin, cycloheptyltripentyltin, dibutyldi(cyclopentyl)tin, di(cyclopentyl)dipentyltin, butyltri(cyclopentyl)tin, tri(cyclopentyl)pentyltin and tetracyclopentyltin.

When the substituents of R¹¹, R¹², L¹ and R²³ to R²⁸ fall in the ranges described above, the electrochemical characteristics in a broad temperature range can be improved to a large extent, and therefore they are preferred.

In the nonaqueous electrolytic solution of the present invention, a content of the organic tin compound represented by Formula (II) and/or (III) described above which is contained in the nonaqueous electrolytic solution is preferably 0.001 to 5% by mass in the nonaqueous electrolytic solution. If the above content is 5% by mass or less, the coating film is less likely to be formed in excess on the electrode and worsened in low-temperature properties. On the other hand, if it is 0.001% by mass or more, the coating film is formed sufficiently well and enhanced in an effect of improving a high-temperature storage property. The above content is preferably 0.008% by mass or more, more preferably 0.02% by mass or more in the nonaqueous electrolytic solution. Also, an upper limit thereof is preferably 3% by mass or less, more preferably 1% by mass or less.

In the nonaqueous electrolytic solution of the present invention, a specific effect of synergistically improving the electrochemical characteristics in a broad temperature range is exerted by combining the organic tin compound represented by Formula (II) and/or (III) with a nonaqueous solvent, an electrolyte salt and other additives which are described below.

### Invention III:

A reason why the nonaqueous electrolytic solution of the invention III can improve the electrochemical characteristics in a broad temperature range to a large extent is not necessarily clear, but it is estimated as follows.

The organic tin compound represented by Formula (IV) described above which is contained in the nonaqueous electrolytic solution of the invention III has substituents on a tin element, wherein at least one of them is a hydrocarbon group, and at least one substituent is bonded to a tin atom via an oxygen atom or a sulfur atom. The coating film of a good quality having in combination the property that it is excellent in a discharging performance at low temperature which originates in a tin atom and an oxygen atom or a sulfur atom and a high heat resistance provided by cyclic carbonate having a fluorine atom or a carbon-carbon double bond is considered to be formed by containing the organic tin compound having the above specific structure and the cyclic carbonate having a fluorine atom or a carbon-carbon double bond in the nonaqueous electrolytic solution. It has been found that because of the above reason, a specific effect of notably improving the electrochemical characteristics in a broad temperature range from low temperature to high temperature is brought about.

The organic tin compound contained in the nonaqueous electrolytic solution of the invention III is represented by the following Formula (IV):

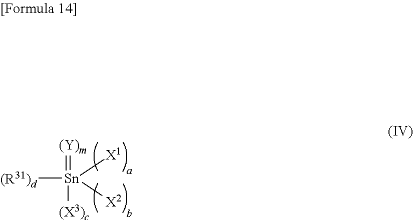

(wherein X¹, X² and X³ each represent independently the following substituents containing an oxygen atom or a sulfur atom:

—OSO₂R³² —OC(O)R³² —OR³² —SR³² —S-L³—OC(O)OR³² —OC(R³²)═CHC(O)R³² —OC(R³³)═CHC(O)R³² [Formula 15]

X¹ and X² may bond to each other to form the following substituents:

—O-L³-O— —S-L³-S— —S-L³-O— —S-L³-C(O)O— [Formula 16]

R³¹ in Formula (IV) represents a linear or branched alkyl group having 1 to 8 carbon atoms, a linear or branched alkenyl group having 2 to 8 carbon atoms, a linear or branched alkynyl group having 2 to 8 carbon atoms or an aryl group having 6 to 12 carbon atoms, and it is preferably a linear or branched alkyl group having 4 to 8 carbon atoms or a linear or branched alkenyl group having 3 to 8 carbon atoms.

R³² and R³³ represent a linear or branched alkyl group having 1 to 8 carbon atoms or an aryl group having 6 to 12 carbon atoms, and it is preferably a linear or branched alkyl group having 1 to 4 carbon atoms.

Y represents an oxygen atom or a sulfur atom, and it is preferably an oxygen atom.

L represents a linear or branched alkylene group having 1 to 8 carbon atoms which may have an ether bond or a carbon-carbon unsaturated bond, and it is preferably a linear or branched alkylene group having 1 to 4 carbon atoms.

Hydrogen atoms of R³¹, R³², R³³ and L³ may be substituted with fluorine atoms.

The terms a, b and c in Formula (IV) represent 0 or 1; d represents an integer of 1 to 3; and m represents 0 or 1. When m is 0, a+b+c+d=4; and when m is 1, a=b=c=0, and d=2.

The specific examples of R³¹ suitably include (i) linear alkyl groups, such as a methyl group, an ethyl group, a n-propyl group, a n-butyl group, a n-pentyl group, a n-hexyl group, a n-heptyl group, a n-octyl group and the like, branched alkyl groups, such as an iso-propyl group, a sec-butyl group, a tert-butyl group, a tert-amyl group and the like, alkyl groups in which a part of hydrogen atoms is substituted with a fluorine atom, such as a fluoromethyl group, a trifluoromethyl group, a 2,2,2-trifluoroethyl group and the like, (ii) linear alkenyl groups, such as a vinyl group; a 2-propene-1-yl group, a 2-butene-1-yl group, a 3-butene-1-yl group, a 4-pentene-1-yl group, a 5-hexene-1-yl group and the like, or branched alkenyl groups, such as a 3-butene-2-yl group, a 2-methyl-1-propene-1-yl group, a 2-methyl-2-propene-1-yl group, a 3-pentene-2-yl group, a 2-methyl-3-butene-2-yl group, a 3-methyl-2-butene-1-yl group and the like, (iii) linear alkynyl groups, such as an ethynyl group, a 2-propyne-1-yl group, a 2-butyne-1-yl group, a 3-butyne-1-yl group, a 4-pentyne-1-yl group, a 5-hexyne-1-yl group and the like, or branched alkynyl groups, such as a 3-butyne-2-yl group, a 3-pentyne-2-yl group, a 2-methyl-3-butyne-2-yl group and the like and (iv) aryl groups, such as a phenyl group, a 2-methylphenyl group, a 3-methylphenyl group, a 4-methylphenyl group, a 4-tert-butylphenyl group, a 4-methoxyphenyl group, a 2,4,6-trimethylphenyl group, a 2-fluorophenyl group, a 3-fluorophenyl group, a 4-fluorophenyl group, a 2,4-difluorophenyl group, a 2,6-difluorophenyl group, a 3,4-difluorophenyl group, a 2,4,6-trifluorophenyl group, a pentafluorophenyl group, a 4-trifluoromethylphenyl group and the like. Among them, a n-butyl group, a n-pentyl group, a n-hexyl group, a n-heptyl group, a n-octyl group and a 2-propene-1-yl group are preferred.

The specific examples of R³² and R³³ suitably include (i) linear alkyl groups, such as a methyl group, an ethyl group, a n-propyl group, a n-butyl group, a n-pentyl group, a n-hexyl group, a n-heptyl group, a n-octyl group and the like; branched alkyl groups, such as an iso-propyl group, a sec-butyl group, a tert-butyl group, a tert-amyl group and the like, alkyl groups in which a part of hydrogen atoms is substituted with a fluorine atom, such as a fluoromethyl group, a trifluoromethyl group, a 2,2,2-trifluoroethyl group and the like and (ii) aryl groups, such as a phenyl group, a 2-methylphenyl group, a 3-methylphenyl group, a 4-methylphenyl group, a 4-tert-butylphenyl group, a 4-methoxyphenyl group, a 2,4,6-trimethylphenyl group, a 2-fluorophenyl group, a 3-fluorophenyl group, a 4-fluorophenyl group, a 2,4-difluorophenyl group, a 2,6-difluorophenyl group, a 3,4-difluorophenyl group, a 2,4,6-trifluorophenyl group, a pentafluorophenyl group, a 4-trifluoromethylphenyl group, and the like. Among them, a methyl group, an ethyl group, a n-propyl group and a n-butyl group are preferred.

The specific examples of L³ suitably include linear alkylene groups, such as a methylene group, an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group and the like, branched alkylene groups, such as a 1,1-ethane-diyl group, a 2,2-dimethyl-1,3-propanediyl group, a 1-methyl-1,2-butanediyl group, a 2-methyl-2,4-pentanediyl group, a 1,2-octanediyl group and the like, alkylene groups having an ether bond or a carbon-carbon unsaturated bond, such as a 1-(butyloxymethyl)ethane-1,2-diyl group, a 1-(allyloxymethyl)ethane-1,2-diyl group, a 2-butene-1,4-diyl group and the like and alkylene groups in which a part of hydrogen atoms is substituted with a fluorine atom, such as a 2,2-difluoropropane-1,3-diyl group and the like. Among them, a methylene group, an ethane-1,2-diyl group and a propane-1,3-diyl group are preferred.

When the substituents of X¹, X², X³ and R³¹ fall in the ranges described above, the electrochemical characteristics in a broad temperature range can be improved to a large extent, and therefore they are preferred.

The compound represented by Formula (IV) includes the following (a) to (f):

(a) organic tin sulfonates (compounds in which m is 0 and in which at least one of X¹, X² and X³ is represented by —OSO₂R³²),
(b) organic tin carboxylates (compounds in which m is 0 and in which at least one of X¹, X² and X³ is represented by —OC(O)R³²),
(c) organic tin alkoxides (compounds in which m is 0 and in which at least one of X¹, X² and X³ is represented by —OR³² or —O-L³-O—),
(d) organic tin β-dicarbonyls (compounds in which m is 0 and in which at least one of X¹, X² and X³ is represented by —OC(R³²)═CHC(O)R³² or —OC(R³³)═CHC(O)OR³²),
(e) organic tin oxides/sulfides (compounds in which m is 1 and in which Y is represented by an oxygen atom or a sulfur atom) and
(f) organic tin thiolates, mercaptooxides and mercaptocarboxylates (compounds in which m is 0 and in which at least one of X¹, X² and X³ is represented by —S-L³-S—, —S-L³-O— or —S-L³-C(O)O—).

To be more specific, the following compounds are shown as the examples thereof, but they shall by no means be restricted by the compounds shown below as the examples.

(a) The organic in sulfonates include compounds having a Sn—OSO₂ bond, such as dimethyltin dimethanesulfonate, diisopropyltin dimethanesulfonate, dicyclohexyltin dimethanesulfonate, dibutyltin dimethanesulfonate, tributyltin methanesulfonate, monobutyltin trimethanesulfonate, dibutyltin diethanesulfonate, dibutyltin bis(trifluoromethanesulfonate), 6,6-dibutyl-1,5,2,4,6-dioxadithiatin 2,2,4,4-tetraoxide [(C₄H₉)₂Sn(—OSO₂C₂SO₂O—)], diphenyltin dimethanesulfonate, diphenyltin bis(trifluoromethanesulfonate) and the like.

Among them, preferred are dimethyltin dimethanesulfonate, dibutyltin dimethanesulfonate, tributyltin methanesulfonate, monobutyltin trimethanesulfonate, dibutyltin diethanesulfonate, dibutyltin bis(trifluoromethanesulfonate) and 6,6-dibutyl-1,5,2,4,6-dioxadithiatin 2,2,4,4-tetraoxide, and further preferred are dibutyltin dimethanesulfonate, dibutyltin diethanesulfonate, dibutyltin bis(trifluoromethanesulfonate) and 6,6-dibutyl-1,5,2,4,6-dioxadithiatin 2,2,4,4-tetraoxide.

(b) The organic tin carboxylates include compounds having a Sn—OC(O) bond, such as dimethyltin diacetate, diisopropyltin diacetate, dibutyltin diacetate, diphenyltin diacetate, tributyltin acetate, dibutyltin diacrylate, dibutyltin dimethacrylate, dibutyltin dibenzoate, dibutyltin bis(hexafluorobenzoate), dibutyltin bis(neodecanoate), dibutyltin bis(2-ethylhexanoate), dibutyltin didodecanoate and the like.

Among them, preferred are dimethyltin diacetate, diisopropyltin diacetate, dibutyltin diacetate, dibutyltin diacrylate, dibutyltin dimethacrylate, dibutyltin dibenZoate, dibutyltin bis(hexafluorobenzoate) and dibutyltin bis(2-ethylhexanoate), and dibutyltin diacetate, dibutyltin diacrylate, dibutyltin dimethacrylate and dibutyltin dibenzoate are further preferred.

(c) The organic tin alkoxides include alkoxides of monohydric alcohols, such as butyltin trimethoxide, dibutyltin dimethoxide, tributyltin methoxide, dioctyltindimethoxide, diphenyltin dimethoxide, dibutyltin dibutoxide, dibutyltin diisopropoxide and the like and organic tin glycolates, such as dibutyltin ethylene glycolate, divinyltin ethylene glycolate, diallyltin ethylene glycolate, dibutyltin (1-hexyl)ethylene glycolate, divinyltin (1-hexyl)ethylene glycolate, dibutyltin (1-vinyloxymethyl)ethylene glycolate, dibutyltin (1-allyloxymethyl)ethylene glycolate, dibutyltin (1-butoxymethyl)ethylene glycolate, dibutyltin 1,3-propylene glycolate, dibutyltin (2,2-dimethyl)-1,3-propylene glycolate, dibutyltin (1,1,3-trimethyl)-1,3-propylene glycolate, dibutyltin (2,2-difluoro)-1,3-propylene glycolate, dibutyltin (2-butenylene)-1,4-glycolate and the like.

Among them, preferred are dibutyltin dimethoxide, dioctyltin dimethoxide, dibutyltin dibutoxide, dibutyltin ethylene glycolate, divinyltin ethylene glycolate, diallyltin ethylene glycolate, dibutyltin (1-hexyl)ethylene glycolate, dibutyltin (1-allyloxymethyl)ethylene glycolate, dibutyltin (1-butoxymethyl)ethylene glycolate, dibutyltin 1,3-propylene glycolate, dibutyltin (2,2-dimethyl)-1,3-propylene glycolate, dibutyltin (2,2-difluoro)-1,3-propylene glycolate and dibutyltin (2-butenylene)-1,4-glycolate, and dibutyltin dimethoxide, dioctyltin dimethoxide, dibutyltin dibutoxide, dibutyltin ethylene glycolate and dibutyltin 1,3-propylene glycolate are further preferred.

(d) The organic tin β-dicarbonyl compounds include organic tin β-diketonate and β-ketoester compounds, such as dibutyltin bis(acetylacetonate), diphenyltin bis(acetylacetonate), tributyltin (acetylacetonate), dibutyltin bis(hexafluoroacetylacetonate), dibutyltin bis(2,2,6,6-tetramethyl-3,5-heptanedionate), dibutyltin bis(2,2-dimethyl-3,5-hexanedionate), dibutyltin bis(methylacetylacetonate), dibutyltin bis(ethylacetylacetonate), dibutyltin bis(benzoylacetonate), dibutyltin bis(dibenzoylmethanate) and the like.

Among them, preferred are dibutyltin bis(acetylacetonate), dibutyltin bis(hexafluoroacetylacetonate), dibutyltin bis(methylacetylacetonate), dibutyltin bis(ethylacetylacetonate) and dibutyltin bis(benzoylacetonate), and dibutyltin bis(acetylacetonate), dibutyltin bis(methylacetylacetonate) and dibutyltin bis(ethylacetylacetonate) are further preferred.

(e) The organic tin oxides/sulfides include compounds having a Sn═O or Sn═S bond, such as dimethyltin oxide, diisopropyltin oxide, divinyltin oxide, diallyltin oxide, dibutyltin oxide, dioctyltih oxide, methylphenyltin oxide, diphenyltin oxide, dicyclohexyltin oxide, dimethyltin dibutyltin sulfide and the like.

Among them, dimethyltin oxide, diisopropyltin oxide, dibutyltin oxide, dioctyltin oxide, methylphenyltin oxide and dicyclohexyltin oxide are preferred, and dibutyltin oxide and dioctyltin oxide are further preferred.

(f) The organic tin thiolates, mercaptooxides and mercaptocarboxylates include compounds containing an Sn—S bond or an O—Sn—S bond, such as monobutyltin tris(methanethiolate), dibutyltin bis(methanethiolate) [(C₄H₉)₂Sn(SCH₃)₂] diphenyltin bis(methanethiolate), tributyltin Methanethiolate, monobutyltin tris(methanethiolate), dibutyltin (1,2-ethanedithiolate), dibutyltin-O,S-monothioethylene glycolate [(C₄H₉)₂Sn(—SCH₂CH₂O—)] and the like and compounds containing an Sn—S-L-C(O)O— bond, such as monomethyltin-S,S,S-tris(isooctyl thioglycolate), monobutyltin-S,S,S-tris(isooctyl thioglycolate), monooctyltin-S,S,S-tris(isooctyl thioglycolate), dimethyltin-S,S-bis(isooctyl thioglycolate), dibutyltin-S,S-bis(isooctyl thioglycolate), dioctyltin-S,S-bis(isooctyl thioglycolate), dibutyltin-S,S-bis(butyl-3-mercaptopropionate), dibutyltin-O,S-thioglycolate [(C₄H₉)₂Sn(—SCH₂CO₂—)], dibutyltin-O,S-(3-mercaptopropionate), dibutyltin-S,S-bis(methyl thioglycolate) [(C₄H₉)₂Sn(SCH₂CO₂CH₃)₂], diphenyltin-S,S-bis(methyl thioglycolate) and the like.

Among them, preferred are monobutyltin tris(methanethiolate), dibutyltin bis(methanethiolate), dibutyltin-1,2-ethanedithiolate, dibutyltin-O,S-monothioethylene glycolate, dibutyltin-S,S-bis(isooctyl thioglycolate), dioctyltin-S,S-bis(isooctyl thioglycolate), dibutyltin-S,S-bis(butyl-3-mercaptopropionate), dibutyltin O,S-thioglycolate, dibutyltin-O,S-(3-mercaptopropionate).and dibutyltin-S,S-bis(methyl thioglycolate), and further preferred are dibutyltin bis(methanethiolate),'dibutyltin-1,2-ethanedithiolate, dibutyltin-O,S-monothioethylene glycolate, dibutyltin-O,S-thioglycolate, dibutyltin-O,S-3-mercaptopropionate and dibutyltin-S,S-bis(methyl thioglycolate).

Among the organic tin compounds described above, (a) the organic tin sulfonates and (b) the organic tin carboxylates are more preferred.

In the nonaqueous electrolytic, solution of the present invention; a content of the organic tin compound represented by Formula (IV) described above which is contained in the nonaqueous electrolytic solution is preferably 0.001 to 5% by mass in the nonaqueous electrolytic solution. If the above content is 5% by mass or less, the coating film is less likely to be formed in excess on the electrode and worsened in low-temperature properties. On the other hand, if it is 0.001% by mass or more, the coating film is formed sufficiently well and enhanced in an effect of improving a high-temperature storage property. The above content is preferably 0.008% by mass or more, more preferably 0.02% by mass or more in the nonaqueous electrolytic solution. Also, an upper limit thereof is preferably 3% by mass or less, more preferably 1% by mass or less.

In the nonaqueous electrolytic solution of the present invention, a specific effect of synergistically improving the electrochemical characteristics in a broad temperature range is exerted by combining the organic tin compound represented by Formula (IV) with a nonaqueous solvent, an electrolyte salt and other additives which are described below.

### Nonaqueous Solvent:

The nonaqueous solvent used for the nonaqueous electrolytic solution of the present invention includes cyclic carbonates, linear esters, ethers, amides, phosphoric esters, sulfones, lactones, nitriles, S═O bond-containing compounds and the like, and both cyclic carbonates and linear esters are preferably contained therein.

The term of the “linear esters” is a concept including linear carbonates and linear carboxylic esters.

The cyclic carbonates suitably include ethylene carbonate (EC), propylene carbonate (PC), 1,2-butylene carbonate, 2,3-butylene carbonate, 4-fluoro-1,3-dioxolane-2-one (FEC), trans- or cis-4,57-difluoro-1,3-dioxolane-2-one (hereinafter, both are generally referred to as “DFEC”), vinylene carbonate (VC), vinyl ethylene carbonate (VEC) and the like.

When the cyclic carbonate is constituted from two or more kinds of cyclic carbonates which do not contain a carbon-carbon double bond among the above carbonates, the electrochemical characteristics in a broad temperature range are improved still more, and therefore it is more preferred. In particular, propylene carbonate is preferably contained as the cyclic carbonate which does not contain a carbon-carbon double bond.

A reason for the matter described above is not necessarily clear, but it is considered to be attributable to that when the cyclic carbonate is constituted from two or more kinds of cyclic carbonates which do not contain a carbon-carbon double bond, the coating film formed using them in combination with the organic tin compound is improved in a heat resistance without too much minute film formation.

A proportion of a volume of propylene carbonate based on the cyclic carbonate is preferably 1% by volume or more, more preferably 5% by volume or more and particularly preferably 10% by volume or more, and an upper limit thereof is preferably 45% by volume or less, further preferably 35% by volume or less and particularly preferably 25% by volume or less.

A content of the cyclic carbonate is used in a range of preferably 10 to 40% by volume based on a whole volume of the nonaqueous solvent. If the content is less than 10% by volume, the nonaqueous electrolytic solution is reduced in an electric conductivity to worsen the electrochemical characteristics in a broad temperature range in a certain case, and if it exceeds 40% by volume, the nonaqueous electrolytic solution is increased in a viscosity, so that the electrochemical characteristics in a broad temperature range are reduced in a certain case. Accordingly, the content falls preferably in the ranges described above.

The suitable combinations of the above cyclic carbonates are preferably EC and PC; EC and FEC; PC and FEC; FEC and DFEC, EC and DFEC; PC and DFEC; EC, PC and FEC and the like.

In the nonaqueous electrolytic solution of the present invention, when the cyclic carbonate having at least a fluorine atom or a carbon-carbon double bond is contained as the cyclic carbonate used in combination with the organic tin compound represented by Formula (IV) described above, a specific effect of synergistically improving the electrochemical characteristics in a broad temperature range is exerted. In particular, preferably contained are 4-fluoro-1,3-dioxolane-2-one (FEC) or 4,5-difluoro-1,3-dioxolane-2-one (DFEC) as the cyclic carbonate having a fluorine atom and Vinylene carbonate (VC) and/or vinyl ethylene carbonate (VEC) as the cyclic carbonate having a carbon-carbon double bond.

In a case of the cyclic carbonate having a fluorine atom, a proportion of a volume thereof based on the cyclic carbonates is preferably 0.1% by volume or more, more preferably 1% by volume or more, further preferably 10% by volume or more, particularly preferably 30% by volume or more and most preferably 55% by volume or more. Also, an upper limit thereof is preferably 90% by volume or less, more preferably 80% by volume or less and further preferably 70% by volume or less.

In a case of the cyclic carbonate having a carbon-carbon double bond, a proportion of a volume thereof based on the cyclic carbonates is preferably 0.1% by volume or more, more preferably 0.5% by volume or more and further preferably 1% by volume or more, and an upper limit thereof is preferably 10% by volume or less, more preferably 5% by volume or less and further preferably 3% by volume or less.

The linear esters suitably include asymmetric linear carbonates, such as methyl ethyl carbonate (MEC), methyl propyl carbonate (MPC), methyl isopropyl carbonate (MIPC), methyl butyl carbonate, ethyl propyl carbonate and the like, symmetric linear carbonates, such as dimethyl carbonate (DMC), diethyl carbonate (DEC), dipropyl carbonate, dibutyl carbonate and the like and linear carboxylic esters, such as methyl propionate, ethyl propionate, methyl acetate, ethyl acetate and the like.

A content of the linear esters shall not specifically be restricted, and they are used in a range of preferably 60 to 90% by volume based on a whole volume of the nonaqueous solvent. If the above content is 60% by volume or more, the nonaqueous electrolytic solution is not increased too much in a viscosity, and if it is 90% by volume or less, the nonaqueous electrolytic solution is less likely to be reduced in an electric conductivity and worsen the electrochemical characteristics in a broad temperature range, so that the content falls preferably in the ranges described above.

Among the linear esters described above, preferred are the linear esters having a methyl group which are selected from dimethyl carbonate, methyl ethyl carbonate, methyl propyl carbonate, methyl isopropyl carbonate, methyl butyl carbonate, methyl propionate, methyl acetate and ethyl acetate, and the linear carbonates having a methyl group are particularly preferred.

Also, when the linear carbonates are used, both of the symmetric linear carbonates and the asymmetric linear carbonates are more preferably contained, and a content of the symmetric linear carbonates is further preferably larger than that of the asymmetric linear carbonates.

A proportion of a volume of the symmetric linear carbonates based on the linear carbonates is 50% by volume or more, more preferably 55% by volume or more. An upper limit thereof is more preferably 95% by volume or less, further preferably 85% by volume or less, and dimethyl carbonate and diethyl carbonate are particularly preferably contained in the symmetric linear carbonate. A content of diethyl carbonate in the nonaqueous solvent is preferably 1% by volume or more, more preferably 2% by volume or more, and an upper limit thereof is preferably 10% by volume or less, more preferably 6% by volume or less.

The asymmetric linear carbonates having a methyl group are more preferred, and MEC is particularly preferred.

In the case described above, the electrochemical characteristics in a further broader temperature range are improved, and therefore it is preferred.

A proportion of the cyclic carbonate to the linear ester is preferably 10:90 to 45:55, more preferably 15:85 to 40:60 and particularly preferably 20:80 to 35:65 in terms of the cyclic carbonate:the linear ester (volume ratio) from the viewpoint of improving the electrochemical characteristics in a broad temperature range.

If the benzene compound (second additive) in which an aliphatic hydrocarbon group having 1 to 6 carbon atoms is bonded to a benzene ring via a tertiary carbon atom or a quaternary carbon atom is further contained in the nonaqueous electrolytic solution, the electrochemical characteristics in a further broader temperature range are improved, and therefore it is preferred. A reason therefor is not necessarily clear, but it is considered to be due to that the benzene ring is adsorbed on the negative electrode and that a branched alkyl group is present on the benzene ring, so that a film originating in at least one organic tin compound represented by any one of Formulas (I) to (IV) described above is improved in a heat resistance without too much minutely depositing.

A content of the benzene compound which is contained in the nonaqueous electrolytic solution and in which an aliphatic hydrocarbon group having 1 to 6 carbon atoms is bonded to a benzene ring via a tertiary carbon atom or a quaternary carbon atom is preferably a mass of 1 to 50 times based on a mass of the organic tin compound represented by any one of Formulas (I) to (IV) described above. If the above content is 50 times or less based on a mass of the organic tin compound represented by any one of Formulas (I) to (IV) described above, the benzene compound is less likely to be adsorbed too much on the negative electrode to reduce the low-temperature properties, and if it is even or more, an effect of adsorbing onto the negative electrode is sufficiently obtained. Accordingly, the content is preferably even or more, further preferably 4 times or more and particularly preferably 10 times or more. An upper limit thereof is preferably 50 times or less, further preferably 40 times or less and particularly preferably 30 times or less.

The benzene compound in which an aliphatic hydrocarbon group having 1 to 6 carbon atoms is bonded to a benzene ring via a tertiary carbon atom or a quaternary carbon atom suitably includes biphenyl, cyclohexylbenzene, fluorocyclohexylbenzene (1-fluoro-2-cyclohexylbenzene, 1-fluoro-3-cyclohexylbenzene, 1-fluoro-4-cyclohexylbenzene), tert-butylbenzene, 1,3-di-tert-butylbenzene, tert-amylbenzene and 1-fluoro-4-tert-butylbenzene. Biphenyl, cyclohexylbenzene, tert-butylbenzene and tert-amylbenzene are more preferred, and tert-butylbenzene and tert-amylbeniene are particularly preferred.

Other nonaqueous solvents suitably include tertiary carboxylic esters, such as methyl pivalate, butyl pivalate, hexyl pivalate, octyl pivalate and the like, oxalic esters, such as dimethyl oxalate, ethyl methyl oxalate, diethyl oxalate and the like, cyclic ethers, such as tetrahydrofuran, 2-methyltetrahydrofuran, 1,3-dioxolane, 1,3-dioxane, 1,4-dioxane and the like, linear ethers, such as 1,2-dimethoxyethane, 1,2-diethoxyethane, 1,2-dibutoxyethane and the like, amides, such as dimethylformamide and the like, phosphoric esters, such as trimethyl phosphate, tributyl phosphate, trioctyl phosphate and the like, sulfones, such as sulfolanes and the like, lactones, such as γ-butyrolactone, γ-valerolactone, α-angelicalactone and the like, nitriles, such as acetonitrile, propionitrile, succinonitrile, glutaronitrilee adiponitrile, pimelonitrile and the like, sultones, such as 1,3-propanesultone, 1,3-butanesultone, 1,4-butanesultone and the like, cyclic sulfites, such as ethylene sulfite, hexahydrobenzo[1,3,2]dioxathiolane-2-oxide (also referred to as 1,2-cyclohexanediol cyclic sulfite), 5-viny-hexahydro-1,3,2-benzodioxathiol-2-oxide, 4-(methylsulfonylmethyl)-1,3,2-dioxathiolane-2-oxide and the like, sulfonic esters, such as 2-propinyl methanesulfonate, butane-1,4-diyl dimethanesulfonate, pentane-1,5-diyl dimethanesulfonate, propane-1,2-diyl dimethanesulfonate, butane-2,3-diyl dimethanesulfonate, methylene methanedisulfonate and the like, S═O bond-containing compounds selected from vinyl sulfones, such as divinyl sulfone, 1,2-bis(vinylsulfonyl)ethane, bis(2-vinylsulfonylethyl)ether and the like, linear carboxylic anhydrides, such as acetic anhydride, propionic anhydride and the like, cyclic acid anhydrides, such as succinic anhydride, maleic anhydride, glutaric anhydride, itaconic anhydride, 3-sulfo-propionic anhydride and the like, cyclic phosphazenes, such as methoxypentafluorocyclotriphosphazene, ethoxypentafluorocyclotriphosphazene, phenoxypentafluorocyclotriphosphazene, ethoxyheptafluorocyclotetraphosphazene and the like, aromatic compounds having a branched alkyl group, such as fluorocyclohexylbenzene (1-fluoro-2-cyclohexylbenzene, 1-fluoro-3-cyclohexylbenzene, 1-fluoro-4-cyclohexylbenzene), 1-fluoro-4-tert-butylbenzene and the like and aromatic compounds, such as biphenyl, terphenyl (o-, m- and p-forms), diphenyl ether, fluorobenzene, difluorobenzene (o-, m- and p-forms), anisole, 2,4-difluoroanisole, partial hydrides of terphenyl (1,2-dicyclohexylbenzne, 2-phenylbicyclohexyl, 1,2-diphenylcyclohexane, o-cyclohexylbiphenyl) and the like.

Among the compounds described above, at least one (third additive) selected from the nitriles, the S═O group-containing compounds having a cyclic structure or an unsaturated group and the sulfonic esters is preferably contained since the electrochemical characteristics in a further broader temperature range are improved.

Among the nitriles, dinitriles are preferred, and above all, dinitriles in which two cyano groups are connected by an aliphatic hydrocarbon group having 2 to 6 carbon atoms are more preferred. Succinonitrile, glutaronitrile, adiponitrile and pimelonitrile are further preferred, and adiponitrile and pimelonitrile are particularly preferred.

Among the S═o group-containing compounds having a cyclic structure or an unsaturated group, preferred are sultones, such as 1,3-propanesultone and the like, cyclic sulfites, such as ethylene sulfite, hexahydrobenzo[1,3,2]dioxathiolane-2-oxide, 5-vinyl-hexahydro-1,3,2-benzodioxathiol-2-oxide, 4-(methylsulfonylmethyl)-1,3,2-dioxathiolane-2-oxide and the like and vinyl sulfones, such as divinyl sulfone, bis(2-vinylsulfonylethyl)ether and the like, and further preferred are hexahydrobenzo[1,3,2]dioxathiolane-2-oxide, 5-vinyl-hexahydro-1,3,2-benzodioxathiol-2-oxide, 4-(methylsulfonylmethyl)-1,3,2-dioxathiolane-2-oxide and bis(2-vinylsulfonylethyl)ether. Particularly preferred are hexahydrobenzo[1,3,2]dioxathiolane-2-oxide, 5-vinyl-hexahydro-1,3,2-benzodioxathiol-2-oxide and 4-(methylsulfonylmethyl)-1,3,2-dioxathiolane-2-oxide which are cyclic sulfites having a branched structure.

Also, among the sulfonic esters, disulfonic esters are preferred, and above all, disulfonic esters in which two sulfonyloxy groups are connected by an aliphatic hydrocarbon group having 2 to 6 carbon atoms are more preferred. Butane-1,4-diyl dimethanesulfonate, pentane-1,5-diyl dimethanesulfonate, propane-1,2-diyl dimethanesulfonate and butane-2,3-diyl dimethanesulfonate are further preferred, and propane-1,2-diyl dimethanesulfonate and butane-2,3-diyl dimethanesulfonate in which two sulfonyloxy groups are connected by a branched alkylene group are particularly preferred.

Among the nitriles, the S═O group-containing compounds having a cyclic structure or an unsaturated group and the sulfonic esters, the S═O group-containing compounds having a cyclic structure or an unsaturated group and the sulfonic esters are particularly preferred.

The contents of the nitriles, the S═O group-containing compounds having a cyclic structure or an unsaturated group and the sulfonic esters are preferably 0.001 to 5% by mass in the nonaqueous electrolytic solution. If the above contents are 5% by mass or less, the coating film is less likely to be formed in excess on the electrode and worsened in low-temperature properties. On the other hand, if they are 0.001% by mass or more, the coating film is formed sufficiently well and enhanced in an effect of improving low-temperature properties after stored at high temperature. The above contents are preferably 0.005% by mass or more, more preferably 0.01% by mass or more, further preferably 0.1% by mass or more and particularly preferably 0.2% by mass or more in the nonaqueous electrolytic solution, and an upper limit thereof is preferably 4% by mass or less, more preferably 3% by mass or less, further preferably 2% by mass or less, further preferably 1% by mass or less and particularly preferably 0.4% by mass or less.

The nonaqueous solvents described above are used usually in a mixture in order to achieve the relevant physical properties. A combination thereof suitably includes, for example, a combination of the cyclic carbonates and the linear carbonates, a combination of the cyclic carbonates, the linear carbonates and the lactones, a combination of the cyclic carbonates, the linear carbonates and the ethers, a combination of the cyclic carbonates, the linear carbonates and the linear esters, a combination of the cyclic carbonates, the linear carbonates and the nitriles and the like.

Also, 0.01 to 0.5% by mass of carbon dioxide is preferably contained in the nonaqueous electrolytic solution since the electrochemical characteristics in a broad temperature range are improved still more.

### Electrolyte Salt:

The electrolyte salt used in the present invention suitably includes the following lithium salts and onium salts.

### Lithium Salts:

The lithium salts suitably include inorganic lithium salts, such as LiPF₆, LiPO₂F₂, LiBF₄, LiClO₄ and the like, lithium salts having a linear alkyl fluoride group, such as LiN(SO₂CF₃)₂, LiN(SO₂C₂F₅)₂,LiCF₃SO₃, LiC(SO₂CF₃)₃, LiPF₄(CF₃)₂, LiPF₃ (C₂F₅)₃ LiPF₃ (CF₃)₃, LiPF₃ (iso-C₃F₇)₃, LiPF₅(iso-C₃F₇) and the like, lithium salts containing a cyclic alkylene fluoride chain, such as (CF₂)₂(SO₂)₂NMi, (CF₂)₃(SO₂)₂NLi and the like and lithium salts with an oxalate complex as an anion therein, such as lithium bis[oxalate-O,O′]borate, lithium difluoro[oxalate-O,O′]borate and the like. Among them, at least one selected from LiPF₆, LiBF₄, LiN(SO₂CF₃)₂ and LiN(SO₂C₂F₅)₂ is preferred, and at least one selected from LiPF₆, LiBF₄ and LiN(SO₂CF₃)₂ is more preferred.

### Onium Salts:

The onium salts suitably include various salts obtained by combining onium cations and anions each shown below.

The specific examples of the onium cations suitably include tetramethylammonium cations, ethyltrimethylammonium cations, diethyldimethylammonium cations, triethylmethylammonium cations, tetraethylammonium cations, N,N-dimethylpyrrolidinium cations, N-ethyl-N-methylpyrrolidinium cations, N,N-diethylpyrrolidinium cations, spiro(N,N′)-bipyrrolidinium cations, N,N′-dimethylimidazolinium cations, N-ethyl-N′-methylimidazolinium cations, N,N′-diethylimidazolinium cations, N,N′-dimethylimidazolium cations, N-ethyl-N′-methylimidazolium cations, N,N′-diethylimidazolium cations and the like.

The specific examples of the anions suitably include PF₆ anions; BF₄ anions, ClO₄ anions, AsF₆ anions, CF₃SO₃ anions, N(CF₃SO₂)₂ anions, N(C₂F₅SO₂)₂ anions and the like.

The above electrolyte salts can be used alone or in combination of two or more kinds thereof.

A concentration of the above electrolyte salts which are used by dissolving is usually preferably 0.3 M or more, more preferably 0.7 M or more and further preferably 1.1 M or more. Also, an upper limit thereof is preferably 2.5 M or less, more preferably 2.0 M or less and further preferably 1.5 M or less.

### Production of Nonaqueous Electrolytic Solution:

The nonaqueous electrolytic solution of the present invention can be obtained, for example, by mixing the nonaqueous solvents described above and adding the electrolyte salt described above to the mixed solvent, wherein at least one organic tin compound represented by any one of Formulas (I) to (IV) is further added to the above nonaqueous electrolytic solution.

In the above case, the nonaqueous solvent used and the compounds added to the nonaqueous electrolytic solution are preferably purified in advance in a range in which the productivity is not notably reduced, and those which are reduced in impurities to the utmost are preferably used.

The nonaqueous electrolytic solution of the present invention can be used for the following first to fourth electrochemical elements, and not only the liquid products but also the gelatinized products can be used as the nonaqueous electrolyte. Further, the nonaqueous electrolytic solution of the present invention can be used as well for a solid polymer electrolyte. Among them, it is used preferably for the first electrochemical element in which a lithium salt is used for an electrolyte salt (that is, for a lithium battery) or the fourth electrochemical element (that is, for a lithium ion capacitor), and it is used further preferably for a lithium battery, most suitably for a lithium secondary battery.

### First Electrochemical Element (Lithium Battery):

The lithium battery of the present invention is a general term for a lithium primary battery and a lithium secondary battery. Also, in the present specification, the term of a lithium secondary battery is used as a concept including as well a so-called lithium ion secondary battery. The lithium battery of the present invention comprises a positive electrode, a negative electrode and the foregoing nonaqueous electrolytic solution prepared by dissolving the electrolyte salt in the nonaqueous solvent. The constitutive components, such as the positive electrode, the negative electrode and the like other than the nonaqueous electrolytic solution can be used without specific restrictions.

For example, complex metal oxides with lithium which contain at least one selected from cobalt, manganese and nickel are used as a positive electrode active material for a lithium secondary battery. The above positive electrode active materials can be used alone or in combination of two or more kinds thereof.

The above lithium complex metal oxides include, for example, LiCoO₂, LiMn₂O₄, LiNiO₂, LiCo₁₋ₓNiₓO₂ (0.01<x<1), LiCo_{1/3}Ni_{1/3}Mn_{1/3}O₂, LiNi_{1/2}Mn_{3/2}O₄, LiCo_{0.98}Mg_{0.02}O₂ and the like. Also, they may be used in combination of LiCoO₂ and LiMn₂O₄, LiCoO₂ and LiNiO₂, and LiMn₂O₄ and LiNiO₂.

In order to improve the safety in overcharging and the cycle property and make it possible to use the battery at a charging electrical potential of 4.3 V or more, a part of the lithium complex metal oxide may be substituted with other elements. For example, a part of cobalt, manganese and nickel can be substituted with at least one element of Sn, Mg, Fe, Ti, Al, Zr, Cr, V, Ga, Zn, Cu, Bi, Mo, La and the like, and a part of O can be substituted with S and F, or the lithium complex metal oxide can be coated with a compound containing the above other elements.

Among them, preferred are the lithium complex metal oxides which can be used at a charging electrical potential of 4.3 V or more based on Li in the positive electrode in a fully charged state, such as LiCoO₂, LiMn₂O₄ and LiNiO₂, and more preferred are the lithium complex metal oxides which can be used at 4.4 V or more, such as solid solutions with LiCo₁₋ₓMₓO₂ (provided that M is at least one element selected from Sn, Mg, Fe, Ti, Al, Zr, Cr, V, Ga, Zn and Cu, 0.001≦x≦0.05), LiCo_{1/3}Ni_{1/3}Mn_{1/3}O₂, LiNi_{1/2}Mn_{3/2}O₄, Li₂MnO₃ and LiMO₂ (M is transition metal, such as Co, Ni, Mn, Fe and the like). When the lithium complex metal oxides which are operated at a higher charged voltage are used, particularly the electrochemical characteristics in a broad temperature range are liable to be reduced due to reaction with the electrolytic solution in charging, but in the lithium secondary battery according to the present invention, the above electrochemical characteristics can be inhibited from being reduced.

Particularly in a case of the positive electrode containing Mn, the battery tends to be liable to be increased in a resistance as Mn ions are eluted from the positive electrode, and therefore the electrochemical characteristics in a broad temperature range tend to be liable to be reduced, but in the lithium secondary battery according to the present invention, the above electrochemical characteristics can be inhibited from being reduced, and therefore it is preferred.

Further, a lithium-containing olivine-type phosphate can also be used as the positive electrode active material. In particular, a lithium-containing olivine-type phosphate containing at least one selected, from iron, cobalt, nickel and manganese is preferred. The specific examples thereof include LiFePO₄, LiCoPO₄, LiNiPO₄, LiMnPO₄ and the like.

A part of the above lithium-containing olivine-type phosphates may be substituted with other elements, and a part of iron, cobalt, nickel and manganese can be substituted with at least one element selected from Co, Mn, Ni, Mg, Al, B, Ti, V, Nb, Cu, Zn, Mo, Ca, Sr, W, Zr and the like or can be coated with a compound containing any one of the above other elements or with a carbon material. Among them, LiFePO₄ or LiMnPO₄ is preferred.

Also, the above lithium-containing olivine-type phosphate can be used as well, for example, in a mixture with the positive electrode active material described above.

Also, the positive electrode for the lithium primary battery includes oxides or chalcogen compounds of one or more metal elements, such as CuO, Cu₂O, Ag₂O, Ag₂CrO₄, CuS, CuSO₄, TiO₂ TiS₂, SiO₂, SnO, V₂O₅, V₆O₁₂, VOₓ, Nb₂O₅, Bi₂O₃, Bi₂Pb₂O₅, Sb₂O₃, CrO₃, Cr₂O₃, MoO₃, WO₃, SeO₂, MnO₂, Mn₂O₃, Fe₂O₃, FeO, Fe₃O₄, Ni₂O₃, NiO, CoO₃, COO and the like, sulfur compounds, such as SO₂, SOCl₂ and the like, carbon fluorides (graphite fluorides) represented by Formula (CFₓ)ₙ and the like. Among them, MnO₂, V₂O₅ and graphite fluorides are preferred.

An electroconductive agent for the positive electrode shall not specifically be restricted as long as it is an electron conductive material which does not bring about chemical change. It includes, for example, graphites, such as natural graphites (flaky graphites and the like), artificial graphites and the like and carbon blacks, such as acetylene blacks, Ketjen blacks, channel blacks, furnace blacks, lamp blacks, thermal blacks and the like. Also, graphites and carbon blacks may be used in a suitable mixture. An addition amount of the electroconductive agent to the positive electrode mixture is preferably 1 to 10% by mass, particularly preferably 2 to 5% by mass.

The positive electrode can be produced by mixing the positive electrode active material described above with the electroconductive agent, such as acetylene blacks, carbon blacks and the like and a binder, such as polytetrafluoroethylene (PTFE), polyvinylidene fluoride (PVDF), copolymers (SBR) of styrene and butadiene, copolymers (NBR) of acrylonitrile and butadiene, carboxymethyl cellulose (CMC), ethylene/propylene/diene terpolymers and the like, adding a high-boiling point solvent, such as 1-methyl-2-pyrrolidone and the like to the mixture and kneading it to prepare a positive electrode mixture, then coating the above positive electrode mixture on a collector, such as an aluminum foil, a stainless-made lath plate and the like, drying and subjecting it to pressure molding and then subjecting it to heating treatment at a temperature of 50 to 250° C. for about 2 hours under vacuum.

A density of parts excluding the collector of the positive electrode is usually 1.5 g/cm³ or more, and in order to improve further a capacity of the battery, it is preferably 2 g/cm³ or more, more preferably 3 g/cm³ or more and further preferably 3.6 g/cm³ or more. An upper limit thereof is preferably 4 g/cm³ or less.

As the negative electrode active material for the lithium secondary battery, lithium metal and lithium alloys, carbon materials which can absorb and release lithium (graphitizable carbons, non-graphitizable carbons in which a lattice (002) spacing (d₀₀₂) is 0.37 nm or more, graphites in which a lattice (002) spacing (d₀₀₂) is 0.34 nm or less), tin (simple substance), tin compounds, silicon (simple substance), silicon compounds and the like can be used alone or in combination of two or more kinds thereof.

Among them, high-crystalline carbon materials, such as artificial graphites, natural graphites and the like are further preferably used in terms of an ability of absorbing and releasing lithium, and carbon materials having a graphite-type crystal structure in which a lattice (002) spacing (d₀₀₂) is 0.340 nm (nanometer) or less, especially 0.335 to 0.337 nm are particularly preferably used.

A ratio (I (110)/I (004)) of a peak intensity T (110) of a (110) plane and a peak intensity I (004) of a (004) plane in the graphite crystal which are obtained from X ray diffraction measurement of the negative electrode sheet subjected to pressure molding so that a density of parts excluding the collector of the negative electrode is 1.5 g/cm³ or more is controlled to 0.01 or more by using artificial graphite particles having a bulky structure in which plural flattened graphite fine particles are put together or combined non-parallel to each other, or graphite particles obtained by exerting repeatedly a mechanical action, such as a compressive force, a friction force, a shearing force and the like on flaky natural graphite particles to subject them to spheroidizing treatment, whereby the electrochemical characteristics in a further broader temperature range are improved, and therefore it is preferred. The ratio is more preferably 0.05 or more, further preferably 0.1 or more. Also, the negative electrode sheet is treated in excess and reduced in a crystallinity to reduce a discharge capacity of the battery in a certain case, and therefore an upper limit of the above ratio is preferably 0.5 or less, more preferably 0.3 or less.

Also, a high-crystalline carbon material (core material) is coated preferably with a lower crystalline carbon material than the core material since the electrochemical characteristics in a broad temperature range are improved still more. A crystallinity of the carbon material for coating can be confirmed by TEM.

When the high-crystalline carbon material is used, it tends to be reacted with the nonaqueous electrolytic solution in charging to reduce the electrochemical characteristics at low temperature or high temperature due to an increase in the interfacial resistance, but in the lithium secondary battery according to the present invention, the electrochemical characteristics in a broad temperature range are improved.

Also, the metal compounds which can absorb and release lithium as the negative electrode active material include compounds containing at least one metal element, such as Si, Ge, Sn, Pb, P, Sb, Bi, Al, Ga, In, Ti, Mn, Fe, Co, Ni, Cu, Zn, Ag, Mg, Sr, Ba and the like. The above metal compounds may be used in any forms of simple substances, alloys, oxides, nitrides, sulfides, borides, alloys with lithium and the like, and any one of the simple substances, the alloys, the oxides and the alloys with lithium is preferred since the capacity can be raised. Among them, the metal compounds containing at least one element selected from Si, Ge and Sn are preferred, and the metal compounds containing at least one element selected from Si and Sn are particularly preferred since the battery can be increased in a capacity.

The negative electrode can be produced by using the same electroconductive agent, binder and high-boiling point solvent as used in producing the positive electrode, kneading them to prepare a negative electrode mixture, then coating the above negative electrode mixture on a copper foil and the like in a collector, drying and subjecting it to pressure molding and then subjecting it to heating treatment at a temperature of 50 to 250° C. for about 2 hours under vacuum.

A density of parts excluding the collector of the negative electrode is usually 1.1 g/cm³ or more, and in order to improve further a capacity of the battery, it is preferably 1.5 g/cm³ or more, particularly preferably 1.7 g/cm³ or more. An upper limit thereof is preferably 2 g/cm³ or less.

Also, the negative electrode active material for the lithium primary battery includes lithium metal or lithium alloys.

A structure of the lithium battery shall not specifically be restricted, and a coin-type battery, a cylinder-type battery, a square-shaped battery, a laminate-type battery and the like which have a single-layered or multi-layered separator can be applied.

The separator for batteries shall not specifically be restricted, and single-layer or laminate fine porous films of polyolefins, such as polypropylene, polyethylene and the like, woven fabrics, unwoven fabrics and the like can be used.

The lithium secondary battery in the present invention is excellent as well in electrochemical characteristics in a broad temperature range when a final charging voltage is 4.2 V or more, especially 4.3 V or more, and it has good characteristics as well in 4.4 V or more. The final discharging voltage can be usually 2.8 V or more, further 2.5 V or more, and in the lithium secondary battery in the present invention, it can be 2.0 V or more. A current value thereof shall not specifically be restricted, and it is used in a range of usually 0.1 to 30 C. Also, the lithium secondary battery in the present invention can be charged and discharged at −40′ to 100° C., preferably −10 to 80° C.

In the present invention, methods in which a safety valve is provided in a battery cap and in which a cutout is formed on members, such as a battery can, a gasket and the like can be employed as a measure for a rise in an internal pressure of the lithium battery. Also, a current cutting-off mechanism which detects an internal pressure of the battery to cut-off a current can be provided in a battery cap as a safety measure for preventing overcharging.

### Second Electrochemical Element (Electric Double Layer Capacitor):

It is an electrochemical element which stores energy by making use of an electric double layer capacitance in the interface between an electrolytic solution and an electrode therein. One example of the present invention is an electric double layer capacitor. A most typical electrode active material used for the above electrochemical element is activated carbon. The double layer capacitance is increased approximately in proportion to the surface area.

### Third Electrochemical Element:

It is an electrochemical element which stores energy by making use of doping/dedoping reaction of an electrode therein. An electrode active material used for the above electrochemical element includes metal oxides, such as ruthenium oxide, iridium oxide, tungsten oxide, molybdenum oxide, copper oxide and the like and π conjugate polymers, such as polyacenes, polythiophene derivatives and the like. Capacitors produced by using the above electrode active materials can store energy generated by doping/dedoping reaction of an electrode.

### Fourth Electrochemical Element (Lithium Ion Capacitor):

It is an electrochemical element which stores energy by making use of intercalation of lithium ions into carbon materials, such as graphite and the like which is the negative electrode. It is called a lithium ion capacitor (LIC). The positive electrode includes, for example, electrodes produced by making use of an electric double layer between an activated carbon electrode and an electrolytic solution therein, or electrodes produced by making use of doping/dedoping reaction of n conjugate polymer electrodes therein. At least a lithium salt, such as LiPF₆ and the like is contained in the electrolytic solution.

### EXAMPLES

Example 6 of electrolytic solutions prepared by using the organic tin compounds of the present invention are shown below, but the present invention shall not be restricted to these examples.

### Examples I-1 to I-16 and Comparative Examples I-1 to I-3

### Production of Lithium Ion Secondary Battery:

LiNi_{1/3}Mn_{1/3}CO_{1/3}O₂: 94% by mass and acetylene black (electroconductive agent): 3% by mass were mixed, and the mixture was added to a solution prepared by dissolving in advance polyvinylidene fluoride (binder): 3% by mass in 1-methyl-2-pyrrolidone and mixed to prepare a positive electrode mixture paste. This positive electrode mixture paste was coated on one surface of an aluminum foil (collector), dried and subjected to pressure treatment, and it was cut into a predetermined size to produce a positive electrode sheet. A density of parts excluding the collector of the positive electrode was 3.6 g/cm³. Further, 95% by mass of artificial graphite (d₀₀₂=0.335 nm, graphite confirmed to be coated with carbon which was less crystalline than the core material by TEM, negative electrode active material) coated with carbon which was lower crystalline than the core material was added to a solution prepared by dissolving in advance 5% by mass of polyvinylidene fluoride (binder) in 1-methyl-2-pyrrolidone and mixed to prepare a negative electrode mixture paste. This negative electrode mixture paste was coated on one surface of a copper foil (collector), dried and subjected to pressure treatment, and it was cut into a predetermined size to produce a negative electrode sheet. A density of parts excluding the collector of the negative electrode was 1.5 g/cm³. Further, X ray diffraction measurement was carried out by using the above electrode sheet to result in finding that a ratio (I (110)/I (004)) of a peak intensity I (110) of a (110) plane and a peak intensity I (004) of a (004) plane in the graphite crystal was 0.1. Then, the positive electrode sheet, a fine porous polyethylene film-made separator and the negative electrode sheet were laminated thereon in this order, and nonaqueous electrolytic solutions having compositions described in Table 1 were added thereto to produce 2032 coin-type batteries.

### Evaluation of Low-Temperature Cycle Property:

The coin-type battery produced by the method described above was used and charged at a constant current of 1C and a constant voltage up to a final voltage of 4.2 V for 3 hours in a thermostatic chamber of 25° C., and then it was discharged at a constant current of 1C up to a final voltage of 2.75 V to thereby carry out precycle. Next, the battery was charged at a constant current of 1C and a constant voltage up to a final voltage of 4.2 V for 3 hours in the thermostatic chamber of 0° C., and then it was discharged at a constant current of 1C up to a final voltage of 2.75 V. This was repeated until it reached 50 cycles. Then, the discharge capacity retention rate at 0° C. after 50 cycles was determined according to the following equation:

discharge capacity retention rate (%) at 0° C. after 50 cycles=(discharge capacity at 0° C. after 50 cycles)/(discharge capacity at 0° C. after 1 cycle)×100

The producing conditions of the batteries and the battery properties are shown in Table 1.

Evaluation of Low-Temperature Properties after Charged and Stored at High Temperature:

### Initial Discharge Capacity:

The coin-type battery produced by the method described above was used and charged at a constant current of 1C and a constant voltage up to a final voltage of 4.2 V for 3 hours in a thermostatic chamber of 25° C., and a temperature of the thermostatic chamber was lowered to 0° C. The battery was discharged up to a final voltage of 2.75 V at a constant current of 1C to determine an initial discharge capacity at 0° C.

### High-Temperature Charging and Storing Test:

Next, the above coin-type battery was charged at a constant current of 1C and a constant voltage up to a final voltage of 4.2 V for 3 hours in a thermostatic chamber of 85° C., and it was stored for 3 days in a state of maintaining at 4.2 V. Then, the battery was put in the thermostatic chamber of 25° C. and once discharged at a constant current of 1C up to a final voltage of 2.75 V.

Discharge Capacity after Charged and Stored at High Temperature:

Further, after that, a discharge capacity at 0° C. after charged and stored at high temperature was determined in the same manner as in measuring the initial discharge capacity.

Low-Temperature Properties after Charged and Stored at High Temperature:

The low-temperature properties after charged and stored at high temperature were determined from the following retention rate of the 0° C. discharge capacity:

0° C. discharge capacity retention rate (%) after charged and stored at high temperature=(discharge capacity at 0° C. after charged and stored at high temperature)/(initial discharge capacity at 0° C.)×100

Also, the producing conditions of the batteries and the battery properties are shown in Table 1.

TABLE 1

| | Composition of | | | | | | | | 0° C. discharge |
|---|---|---|---|---|---|---|---|---|---|
| | electrolyte salt | | | | | | | Discharge | capacity retention |
| | composition of nonaqueous | | Addi- | | Addi- | | Addi- | capacity | rate (%) after |
| | electrolytic | Organic | tion | | tion | | tion | retention | 85° C. high- |
| | solution (volume ratio | tin | amount | Second | amount | Third | amount | rate (%) after | temperature charge |
| | of solvent) | compound | *1 | additive | *1 | additive | *1 | 0° C. 50 cycles | and storage |
| Example I-1 | 1.2M LiPF₆ | tributyl- | 0.01 | none | — | none | — | 72 | 74 |
| | EC/PC/DMC/MEC/DEC | (2-propene- | | | | | | | |
| | (25/5/50/15/5) | 1-yl)tin | | | | | | | |
| Example I-2 | 1.2M LiPF₆ | tributyl- | 0.08 | none | — | none | — | 76 | 78 |
| | EC/PC/DMC/MEC/DEC | (2-propene- | | | | | | | |
| | (25/5/50/15/5) | 1-yl)tin | | | | | | | |
| Example I-3 | 1.2M LiPF₆ | tributyl- | 0.4 | none | — | none | — | 70 | 69 |
| | EC/PC/DMC/MEC/DEC | (2-propene- | | | | | | | |
| | (25/5/50/15/5) | 1-yl)tin | | | | | | | |
| Example I-4 | 1.2M LiPF₆ | tributyl- | 0.08 | none | — | none | — | 74 | 73 |
| | EC/PC/DMC/MEC/DEC | (2-propene- | | | | | | | |
| | (25/5/60/5/5) | 1-yl)tin | | | | | | | |
| Example I-5 | 1.2M LiPF₆ | tributyl- | 0.08 | none | — | none | — | 72 | 71 |
| | EC/PC/DMC/MEC/DEC | (2-propene- | | | | | | | |
| | (25/5/35/30/5) | 1-yl)tin | | | | | | | |
| Example I-6 | 1.2M LiPF₆ | tetra- | 0.08 | none | — | none | — | 74 | 75 |
| | EC/PC/DMC/MEC/DEC | butyltin | | | | | | | |
| | (25/5/50/15/5) | | | | | | | | |
| Example I-7 | 1.2M LiPF₆ | tetra- | 0.08 | none | — | none | — | 75 | 77 |
| | EC/PC/DMC/MEC/DEC | pentyltin | | | | | | | |
| | (25/5/50/15/5) | | | | | | | | |
| Example I-8 | 1.2M LiPF₆ | tetra- | 0.08 | none | — | none | — | 79 | 79 |
| | EC/PC/FEC/DMC/MEC | butyltin | | | | | | | |
| | (20/5/5/50/20) | | | | | | | | |
| Example I-9 | 1.2M LiPF₆ | tetra- | 0.08 | none | — | none | — | 77 | 78 |
| | EC/PC/FEC/DMC/MEC | butyltin | | | | | | | |
| | (5/5/20/50/20) | | | | | | | | |
| Example I-10 | 1.2M LiPF₆ | tributyl- | 0.08 | t-amyl- | 1.6 | none | — | 79 | 80 |
| | EC/PC/DMC/MEC/DEC | (2-propene- | | benzene | | | | | |
| | (25/5/50/15/5) | 1-yl)tin | | | | | | | |
| Example I-11 | 1.2M LiPF₆ | tributyl- | 0.08 | t-amyl- | 0.8 | none | — | 77 | 79 |
| | EC/PC/DMC/MEC/DEC | (2-propene- | | benzene | | | | | |
| | (25/5/50/15/5) | 1-yl)tin | | | | | | | |
| Example I-12 | 1.2M LiPF₆ | tributyl- | 0.08 | t-amyl- | 0.4 | none | | 76 | 76 |
| | EC/PC/DMC/MEC/DEC | (2-propene- | | benzene | | | | | |
| | (25/5/50/15/5) | 1-yl)tin | | | | | | | |
| Example I-13 | 1.2M LiPF₆ | tributyl- | 0.4 | t-amyl- | 0.4 | none | — | 73 | 69 |
| | EC/PC/DMC/MEC/DEC | (2-propene- | | benzene | | | | | |
| | (25/5/50/15/5) | 1-yl)tin | | | | | | | |
| Example I-14 | 1.2M LiPF₆ + | tributyl- | 0.08 | t-amyl- | 1.6 | Adipo- | 0.4 | 81 | 83 |
| | 0.02M LiPO₂F₂ | (2-propene- | | benzene | | nitrile | | | |
| | EC/PC/DMC/MEC/DEC | 1-yl)tin | | | | | | | |
| | (25/5/50/15/5) | | | | | | | | |
| Example I-15 | 1.2M LiPF₆ | tributyl- | 0.08 | t-amyl- | 1.6 | *2 | 0.2 | 80 | 82 |
| | EC/PC/DMC/MEC/DEC | (2-propene- | | benzene | | | | | |
| | (25/5/50/15/5) | 1-yl)tin | | | | | | | |
| Example I-16 | 1.2M LiPF₆ | tributyl- | 0.08 | t-amyl- | 1.6 | *3 | 1 | 82 | 84 |
| | EC/PC/DMC/MEC/DEC | (2-propene- | | benzene | | | | | |
| | (25/5/50/15/5) | 1-yl)tin | | | | | | | |
| Comparative | 1.2M LiPF₆ | none | — | none | — | none | — | 63 | 62 |
| Example I-1 | EC/PC/DMC/MEC/DEC | | | | | | | | |
| | (25/5/50/15/5) | | | | | | | | |
| Comparative | 1M LiPF₆ | dibutyltin | 0.6 | none | — | none | — | 64 | 53 |
| Example I-2 | EC/DMC/MEC | (1-allyloxy- | | | | | | | |
| | (30/30/40) | methyl)- | | | | | | | |
| | | ethylene | | | | | | | |
| | | glycolate | | | | | | | |
| Comparative | 1M LiPF₆ | tetra- | 0.08 | none | — | none | — | 60 | 55 |
| Example I-3 | EC/VC/DEC | butyltin | | | | | | | |
| | (29/1/70) | | | | | | | | |

*1: content (wt %) in nonaqueous electrolytic solution
*2: 4-(methylsulfonylmethyl)-1,3,2-dioxathiolane-2-oxide
*3: butane-2,3-diyl dimethanesulfonate

### Examples I-17 and I-18 and Comparative Examples I-4

Elemental silicon (negative electrode active material) was used in place of the negative electrode active material used in Example I-2 and Comparative Example I-1 to produce a negative electrode sheet. Silicon (simple substance): 80% by mass and acetylene black (electroconductive agent): 15% by mass were mixed, and the mixture was added to a solution prepared by dissolving in advance polyvinylidene fluoride (binder): 5% by mass in 1-methyl-2-pyrrolidone and mixed to prepare a negative electrode mixture paste. Coin-type batteries were produced in the same manners as in Example I-2 and Comparative Example I-1 to evaluate the batteries, except that the above negative electrode mixture paste was coated on a copper foil (collector), dried and subjected to pressure treatment and that it was cut into a predetermined size to produce a negative electrode sheet. The results thereof are shown in Table 2.

TABLE 2

| | Composition of | | | | | | | | 0° C. discharge |
|---|---|---|---|---|---|---|---|---|---|
| | electrolyte salt | | | | | | | Discharge | capacity retention |
| | composition of | | Addi- | | Addi- | | Addi- | capacity | rate (%) after |
| | nonaqueous electrolytic | Organic | tion | | tion | | tion | retention | 85° C. high- |
| | solution (volume ratio | tin | amount | Second | amount | Third | amount | rate (%) after | temperature charge |
| | of solvent) | compound | *1 | additive | *1 | additive | *1 | 0° C. 50 cycles | and storage |
| Example I-17 | 1.2M LiPF₆ | tributyl- | 0.08 | none | — | none | — | 63 | 62 |
| | EC/PC/DMC/MEC/DEC | (2-propene- | | | | | | | |
| | (25/5/50/15/5) | 1-yl)tin | | | | | | | |
| Example I-18 | 1.2M LiPF₆ | tributyl- | 0.08 | t-amyl- | 1.6 | *3 | 1 | 66 | 65 |
| | EC/PC/DMC/MEC/DEC | (2-propene- | | benzene | | | | | |
| | (25/5/50/15/5) | 1-yl)tin | | | | | | | |
| Comparative | 1.2M LiPF₆ | none | — | none | — | none | — | 45 | 41 |
| Example I-4 | EC/PC/DMC/MEC/DEC | | | | | | | | |
| | (25/5/50/15/5) | | | | | | | | |

*1: content (wt %) in nonaqueous .electrolytic solution
*3: butane-2,3 -diyl dimethanesulfonate

### Examples I-19 and I-20 and Comparative Examples I-5

LiFePO₄ (positive electrode active material) coated with amorphous carbon was used in place of the positive electrode active material used in Example I-2 and Comparative Example I-1 to produce a positive electrode sheet. LiFePO₄ coated with amorphous carbon: 90% by mass and acetylene black (electroconductive agent): 5% by mass were mixed, and the mixture was added to a solution prepared by dissolving in advance polyvinylidene fluoride (binder): 5% by mass in 1-methyl-2-pyrrolidone and mixed to prepare a positive electrode mixture paste. Coin-type batteries were produced in the same manners as in Example I-2 and Comparative Example I-1 to evaluate the batteries, except that the above positive electrode mixture paste was coated on an aluminum foil (collector), dried and subjected to pressure treatment, followed by punching it into a prescribed size to produce a positive electrode sheet and that controlled were a final charging voltage to 3.6 V and a final discharging voltage to 2.0 V in evaluating the batteries. The results thereof are shown in Table 3.

TABLE 3

| | Composition of | | | | | | | | 0° C. discharge |
|---|---|---|---|---|---|---|---|---|---|
| | electrolyte salt | | | | | | | Discharge | capacity retention |
| | composition of | | Addi- | | Addi- | | Addi- | capacity | rate (%) after |
| | nonaqueous electrolytic | Organic | tion | | tion | | tion | retention | 85° C. high- |
| | solution (volume ratio | tin | amount | Second | amount | Third | amount | rate (%) after | temperature charge |
| | of solvent) | compound | *1 | additive | *1 | additive | *1 | 0° C. 50 cycles | and storage |
| Example I-19 | 1.2M LiPF₆ | tributyl- | 0.08 | none | — | none | — | 75 | 74 |
| | EC/PC/DMC/MEC/DEC | (2-propene- | | | | | | | |
| | (25/5/50/15/5) | 1-yl)tin | | | | | | | |
| Example I-20 | 1.2M LiPF₆ | tributyl- | 0.08 | t-amyl- | 1.6 | *3 | 1 | 79 | 77 |
| | EC/PC/DMC/MEC/DEC | (2-propene- | | benzene | | | | | |
| | (25/5/50/15/5) | 1-yl)tin | | | | | | | |
| Comparative | 1.2M LiPF₆ | none | — | none | — | none | — | 65 | 60 |
| Example I-5 | EC/PC/DMC/MEC/DEC | | | | | | | | |
| | (25/5/50/15/5) | | | | | | | | |

*1: content (wt %) in nonaqueous electrolytic solution
*3: butane-2,3-diyl dimethanesulfonate

All of the lithium secondary batteries produced in Examples I-1 to I-16 were notably improved in electrochemical characteristics in a broad temperature range as compared with the lithium secondary batteries produced in Comparative Example I-1 in which the organic tin compound was not added in the nonaqueous electrolytic solution having a constitution of the nonaqueous solvents according to the present invention, Comparative Example I-2 using the nonaqueous electrolytic solution prepared by adding dibutyltin (1-allyloxymethyl)ethylene glycolate which was an organic tin compound described in Example 3 of the patent document 1 and Comparative Example I-3 in which tetrabutyltin was added to a nonaqueous electrolytic solution (provided that the organic tin compound was excluded, solvent composition: EC/VC/DEC 29/1/70) used in Example 1 and the like of the patent document 2. It became clear from the above matters that the effects of the present invention were effects peculiar to a case in which in the nonaqueous electrolytic solution prepared by dissolving the electrolyte salt in the nonaqueous solvent, the above nonaqueous solvent contained cyclic carbonate and linear carbonate, in which the above linear carbonate contained at least both symmetric linear carbonate and asymmetric linear carbonate, in which a content of the symmetric linear carbonate was larger than that of the asymmetric linear carbonate and in which 0.001 to 1% by mass of the specific organic tin compound of the present invention was contained in the nonaqueous electrolytic solution.

Also, from comparisons of Examples I-17 and I-18 with Comparative Example I-4, and Examples I-19 and I-20 with Comparative Example I-5, the same effect is observed as well in a case in which Si was used for the negative electrode and a case in which lithium-containing olivine-type iron phosphate was used for the positive electrode. Accordingly, it is apparent that the effects of the present invention are not effects depending on the specific positive electrode and negative electrode.

Further, the nonaqueous electrolytic solutions of the present invention have as well an effect of improving discharging properties in a broad temperature range in the lithium primary batteries.

### Examples II-1 to II-12 and Comparative Examples II-1 to II-2

### Production of Lithium Ion Secondary Battery:

LiCoO₂: 94% by mass and acetylene black (electroconductive agent): 3% by mass were mixed, and the mixture was added to a solution prepared by dissolving in advance polyvinylidene fluoride (binder): 3% by mass in 1-methyl-2-pyrrolidone and mixed to prepare a positive electrode mixture paste. This positive electrode mixture paste was coated on one surface of an aluminum foil (collector), dried and subjected to pressure treatment, and it was cut into a predetermined size to produce a positive electrode sheet. A density of parts excluding the collector of the positive electrode was 3.6 g/cm³. Further, 95% by mass of artificial graphite (d₀₀₂=0.335 nm, negative electrode active material) was added to a solution prepared by dissolving in advance 5% by mass of polyvinylidene fluoride (binder) in 1-methyl-2-pyrrolidone and mixed to prepare a negative electrode mixture paste. This negative electrode mixture paste was coated on one surface of a copper foil (collector), dried and subjected to pressure treatment, and it was cut into a predetermined size to produce a negative electrode sheet. A density of parts excluding the collector of the negative electrode was 1.5 g/cm³. Further, X ray diffraction measurement was carried out by using the above electrode sheet to result in finding that a ratio (I (110)/I (004)) of a peak intensity I (110) of a (110) plane and a peak intensity I (004) of a (004) plane in the graphite crystal was 0.1. Then, the positive electrode sheet, a fine porous polyethylene film-made separator and the negative electrode sheet were laminated thereon in this order, and nonaqueous electrolytic solutions having compositions described in Table 4 were added thereto to produce 2032 coin-type batteries.

The low-temperature cycle property and the low-temperature properties after, charged and stored at high temperature (the initial discharge capacity, the high-temperature charging and storing test, the discharge capacity after charged and stored at high temperature and the low-temperature properties after charged and stored at high temperature) were evaluated by the same methods as described above.

The producing conditions of the batteries and the battery properties are shown in Table 4.

TABLE 4

| | Composition of | | | | | | | | 0° C. discharge |
|---|---|---|---|---|---|---|---|---|---|
| | electrolyte salt | | | | | | | Discharge | capacity retention |
| | composition of | | Addi- | | Addi- | | Addi- | capacity | rate (%) after |
| | nonaqueous electrolytic | Organic | tion | | tion | | tion | retention | 85° C. high- |
| | solution (volume ratio | tin | amount | Second | amount | Third | amount | rate (%) after | temperature charge |
| | of solvent) | compound | *1 | additive | *1 | additive | *1 | 0° C. 50 cycles | and storage |
| Example II-1 | 1.2M LiPF₆ | 1,1-dibutyl- | 0.01 | none | — | none | — | 72 | 78 |
| | EC/DMC/MEC | 1-stanna- | | | | | | | |
| | (30/50/20) | cycloheptane | | | | | | | |
| Example II-2 | 1.2M LiPF₆ | 1,1-dibutyl- | 0.08 | none | — | none | — | 74 | 82 |
| | EC/DMC/MEC | 1-stanna- | | | | | | | |
| | (30/50/20) | cycloheptane | | | | | | | |
| Example II-3 | 1.2M LiPF₆ | 1,1-dibutyl- | 2 | none | — | none | — | 69 | 73 |
| | EC/DMC/MEC | 1-stanna- | | | | | | | |
| | (30/50/20) | cycloheptane | | | | | | | |
| Example II-4 | 1.2M LiPF₆ | 1,1-dibutyl- | 0.08 | none | — | none | — | 71 | 80 |
| | EC/DMC/MEC | 1-stanna- | | | | | | | |
| | (30/50/20) | cycloheptane | | | | | | | |
| Example II-5 | 1.2M LiPF₆ | 1,1-dibutyl- | 0.08 | none | — | none | — | 76 | 83 |
| | EC/DMC/MEC | 1-stanna- | | | | | | | |
| | (30/50/20) | cycloheptane | | | | | | | |
| Example II-6 | 1.2M LiPF₆ | 1,1-di(2- | 0.08 | none | — | none | — | 77 | 85 |
| | EC/DMC/MEC | propene-1- | | | | | | | |
| | (30/50/20) | yl)-1-stanna- | | | | | | | |
| | | cycloheptane | | | | | | | |
| Example II-7 | 1.2M LiPF₆ | 6-stanna- | 0.08 | none | — | none | — | 75 | 84 |
| | EC/DMC/MEC | spiro[5,5]- | | | | | | | |
| | (30/50/20) | undecane | | | | | | | |
| Example II-8 | 1.2M LiPF₆ | dibutyl- | 0.08 | none | — | none | — | 72 | 77 |
| | EC/DMC/MEC | diisopropyl- | | | | | | | |
| | (30/50/20) | tin | | | | | | | |
| Example II-9 | 1.2M LiPF₆ | tributyl- | 0.08 | none | — | none | — | 74 | 78 |
| | EC/DMC/MEC | cyclopentyl- | | | | | | | |
| | (30/50/20) | tin | | | | | | | |
| Example II-10 | 1.2M LiPF₆ | tetra- | 0.08 | none | — | none | — | 77 | 81 |
| | EC/DMC/MEC | cyclopentyl- | | | | | | | |
| | (30/50/20) | tin | | | | | | | |
| Example II-11 | 1.2M LiPF₆ | 1,1-dibutyl- | 0.08 | t-amyl- | 1.6 | *2 | 1 | 79 | 86 |
| | EC/PC/DMC/MEC/DEC | 1-stanna- | | benzene | | | | | |
| | (25/5/50/15/5) | cycloheptane | | | | | | | |
| Example II-12 | 1.2M LiPF₆ | tributyl- | 0.08 | t-amyl- | 1.6 | *2 | 1 | 78 | 83 |
| | EC/PC/DMC/MEC/DEC | cyclopentyl- | | benzene | | | | | |
| | (25/5/50/15/5) | tin | | | | | | | |
| Comparative | 1.2M LiPF₆ | none | — | none | — | none | — | 64 | 61 |
| Example II -1 | EC/DMC/MEC | | | | | | | | |
| | (30/50/20) | | | | | | | | |
| Comparative | 1.2M LiPF₆ | dibutyltin | 0.6 | none | — | none | — | 66 | 52 |
| Example II-2 | EC/DMC/MEC | (1-allyloxy- | | | | | | | |
| | (30/30/40) | methyl)- | | | | | | | |
| | | ethylene | | | | | | | |
| | | glycolate | | | | | | | |

*1: content (wt %) in nonaqueous electrolytic solution
*2: pentane-1,5-diyl dimethanesulfonate

### Examples II-13 to II-14 and Comparative Example 11-3

Elemental silicon (negative electrode active material) was used in place of the negative electrode active material used in Example II-2, Example II-9 and Comparative Example II-1 to produce a negative electrode sheet. Silicon (simple substance): 80% by mass and acetylene black (electroconductive agent): 15% by mass were mixed, and the mixture was added to a solution prepared by dissolving in advance polyvinylidene fluoride (binder): 5% by mass in 1-methyl-2-pyrrolidone and mixed to prepare a negative electrode mixture paste. Coin-type batteries were produced in the same manners as in Example II-2, Example II-9 and Comparative Example II-1 to evaluate the batteries, except that the above negative electrode mixture paste was coated on a copper foil (collector), dried and subjected to pressure treatment and that it was punched into a prescribed size to produce a negative electrode sheet. The results thereof are shown in Table 5.

TABLE 5

| | | | | | 0° C. discharge |
|---|---|---|---|---|---|
| | Composition of | | | | capacity |
| | electrolyte salt | | | Discharge | retention |
| | composition of | | | capacity | rate (%) after |
| | nonaqueous | | | retention | 85° C. |
| | electrolytic | Organic | Addition | rate (%) | high-temperature |
| | solution (volume | tin | amount | after 0° C. | charge |
| | ratio of solvent) | compound | *1 | 50 cycles | and storage |
| Example | 1.2M LiPF₆ | 1,1-dibutyl- | 0.08 | 65 | 63 |
| II-13 | EC/DMC/MEC | 1-stanna- | | | |
| | (30/50/20) | cycloheptane | | | |
| Example | 1.2M LiPF₆ | tributyl- | 0.08 | 61 | 65 |
| II-14 | EC/DMC/MEC | cyclopentyl- | | | |
| | (30/50/20) | tin | | | |
| Comparative | 1.2M LiPF₆ | none | — | 44 | 39 |
| Example | EC/DMC/MEC | | | | |
| II-3 | (30/50/20) | | | | |

*1: content (wt %) in nonaqueous electrolytic solution

### Examples II-15 to II-16 and Comparative Example II-4

LiFePO₄ (positive electrode active material) coated with amorphous carbon was used in place of the positive electrode active material used in Example II-2, Example II-9 and Comparative Example II-1 to produce a positive electrode sheet. LiFePO₄ coated with amorphous carbon: 90% by mass and acetylene black (electroconductive agent): 5% by mass were mixed, and the mixture was added to a solution prepared by dissolving in advance polyvinylidene fluoride (binder): 5% by mass in 1-methyl-2-pyrrolidone and mixed to prepare a positive electrode mixture paste. Coin-type batteries were produced in the same manners as in Example II-2, Example II-9 and Comparative Example II-1 to evaluate the batteries, except that the above positive electrode mixture paste was coated on an aluminum foil (collector), dried and subjected to pressure treatment, followed by punching it into a prescribed size to produce a positive electrode sheet and that controlled were a final charging voltage to 3.6 V and a final discharging voltage to 2.0 V in evaluating the batteries. The results thereof are shown in Table 6.

TABLE 6

| | | | | | 0° C. discharge |
|---|---|---|---|---|---|
| | Composition of | | | | capacity |
| | electrolyte salt | | | Discharge | retention |
| | composition of | | | capacity | rate (%) after |
| | nonaqueous | | | retention | 85° C. |
| | electrolytic | Organic | Addition | rate (%) | high-temperature |
| | solution (volume | tin | amount | after 0° C. | charge |
| | ratio of solvent) | compound | *1 | 50 cycles | and storage |
| Example | 1.2M LiPF₆ | 1,1-dibutyl- | 0.08 | 80 | 79 |
| II-15 | EC/DMC/MEC | 1-stanna- | | | |
| | (30/50/20) | cycloheptane | | | |
| Example | 1.2M LiPF₆ | tributyl- | 0.08 | 76 | 75 |
| II-16 | EC/DMC/MEC | cyclopentyl- | | | |
| | (30/50/20) | tin | | | |
| Comparative | 1.2M LiPF₆ | none | — | 66 | 58 |
| Example | EC/DMC/MEC | | | | |
| II-4 | (30/50/20) | | | | |

*1: content (wt %) in nonaqueous electrolytic solution

All of the lithium secondary batteries produced in Examples II-1 to II-12 were notably improved in electrochemical characteristics in a broad temperature range as compared with the lithium secondary batteries produced in Comparative Example II-1 in which the organic tin compound was not added in the nonaqueous electrolytic solution of the present invention and Comparative Example II-2 using the nonaqueous electrolytic solution prepared by adding dibutyltin (1-allyloxymethyl)ethylene glycolate which was an organic compound described in Example 3 of the patent document 1. It became clear from the above matters that the effects of the present invention were effects peculiar to a case in which 0.001 to 5% by mass of the specific organic tin compound of the present invention was contained in the nonaqueous electrolytic solution prepared by dissolving the electrolyte salt in the nonaqueous solvent.

Also, from comparisons of Examples II-13 and II-14 with Comparative Example II-3, and Examples II-15 and II-16 with Comparative Example II-4, the same effect is observed as well in a case in which silicon (simple substance) was used for the negative electrode and a case in which lithium-containing olivine-type iron phosphate was used for the positive electrode. Accordingly, it is apparent that the effects of the present invention are not effects depending on the specific positive electrode and negative electrode.

Further, the nonaqueous electrolytic solutions of the present invention have as well an effect of improving discharging properties in a broad temperature range in the lithium primary batteries.

### Examples III-1 to III-25 and Comparative Examples III-1 to III-2

### Production of Lithium Ion Secondary Battery:

LiCoO₂: 94% by mass and acetylene black (electroconductive agent): 3% by mass were mixed, and the mixture was added to a solution prepared by dissolving in advance polyvinylidene fluoride (binder): 3% by mass in 1-methyl-2-pyrrolidone and mixed to prepare a positive electrode mixture paste. This positive electrode mixture paste was coated on one surface of an aluminum foil (collector), dried and subjected to pressure treatment, and it was cut into a predetermined size to produce a positive electrode sheet. A density of parts excluding the collector of the positive electrode was 3.6 g/cm³. Further, 95% by mass of artificial graphite (d₀₀₂=0.335 nm, negative electrode active material) was added to a solution prepared by dissolving in advance 5% by mass of polyvinylidene fluoride (binder) in 1-methyl-2-pyrrolidone and mixed to prepare a negative electrode mixture paste. This negative electrode mixture paste was coated on one surface of a copper foil (collector), dried and subjected to pressure treatment, and it was cut into a predetermined size to produce a negative electrode sheet. A density of parts excluding the collector of the negative electrode was 1.5 g/cm³. Further, X ray diffraction measurement was carried out by using the above electrode sheet to result in finding that a ratio (I (110)/I (004)) of a peak intensity I (110) of a (110) plane and a peak intensity I (004) of a (004) plane in the graphite crystal was 0.1. Then, the positive electrode sheet, a fine porous polyethylene film-made separator and the negative electrode sheet were laminated thereon in this order, and nonaqueous electrolytic solutions having compositions described in Table 7 were added thereto to produce 2032 coin-type batteries.

The low-temperature cycle property and the low-temperature properties after charged and stored at high temperature (the initial discharge capacity, the high-temperature charging and storing test, the discharge capacity after charged and stored at high temperature and the low-temperature properties after charged and stored at high temperature) were evaluated by the same methods as described above.

The producing conditions of the batteries and the battery properties are shown in Table 7 and Table 8.

TABLE 7

| | Composition of | | | | |
|---|---|---|---|---|---|
| | electrolyte salt | | | Discharge | 0° C. discharge |
| | composition of | | | capacity | capacity retention |
| | nonaqueous | | | retention | rate (%) after |
| | electrolytic | Organic | Addition | rate (%) | 85° C. high- |
| | solution (volume | tin | amount | after 0° C. | temperature charge |
| | ratio of solvent) | compound | *1 | 50 cycles | and storage |
| Example | 1.2M LiPF₆ | dibutyltin | 0.01 | 73 | 75 |
| III-1 | EC/VC/DMC/MEC | dimethane- | | | |
| | (29/1/50/20) | sulfonate | | | |
| Example | 1.2M LiPF₆ | dibutyltin | 0.08 | 77 | 79 |
| III-2 | EC/VC/DMC/MEC | dimethane- | | | |
| | (29/1/50/20) | sulfonate | | | |
| Example | 1.2M LiPF₆ | dibutyltin | 0.4 | 71 | 73 |
| III-3 | EC/VC/DMC/MEC | dimethane- | | | |
| | (29/1/50/20) | sulfonate | | | |
| Example | 1.2M LiPF₆ | dibutyltin | 2 | 70 | 71 |
| III-4 | EC/VC/DMC/MEC | dimethane- | | | |
| | (29/1/50/20) | sulfonate | | | |
| Example | 1.2M LiPF₆ | 6,6-dibutyl- | 0.08 | 78 | 80 |
| III-5 | EC/VC/DMC/MEC | 1,5,2,4,6- | | | |
| | (29/1/50/20) | dioxadithiatin | | | |
| | | 2,2,4,4- | | | |
| | | tetraoxide | | | |
| Example | 1.2M LiPF₆ | butyltin | 0.08 | 70 | 73 |
| III-6 | EC/VC/DMC/MEC | trimethane- | | | |
| | (29/1/50/20) | sulfonate | | | |
| Example | 1.2M LiPF₆ | dibutyltin | 0.08 | 74 | 75 |
| III-7 | EC/VC/DMC/MEC | diacetate | | | |
| | (29/1/50/20) | | | | |
| Example | 1.2M LiPF₆ | dibutyltin | 0.08 | 71 | 74 |
| III-8 | EC/VC/DMC/MEC | oxide | | | |
| | (29/1/50/20) | | | | |
| Example | 1.2M LiPF₆ | dibutyltin- | 0.08 | 72 | 74 |
| III-9 | EC/VC/DMC/MEC | O,S-thio- | | | |
| | (29/1/50/20) | glycolate | | | |
| Example | 1.2M LiPF₆ | dibutyltin- | 0.08 | 70 | 72 |
| III-10 | EC/VC/DMC/MEC | O,S- | | | |
| | (29/1/50/20) | monothio- | | | |
| | | ethylene | | | |
| | | glycolate | | | |
| Example | 1.2M LiPF₆ | dibutyltin | 0.08 | 68 | 71 |
| III-11 | EC/VC/DMC/MEC | dimethyl- | | | |
| | (29/1/50/20) | mercaptide | | | |
| Example | 1.2M LiPF₆ | dibutyltin- | 0.08 | 69 | 72 |
| III-12 | EC/VC/DMC/MEC | S,S-bis- | | | |
| | (29/1/50/20) | (methylthio- | | | |
| | | glycolate) | | | |
| Example | 1.2M LiPF₆ | dibutyltin | 0.08 | 74 | 76 |
| III-13 | EC/VC/DMC/MEC | dimethane- | | | |
| | (29.8/0.2/50/20) | sulfonate | | | |
| Example | 1.2M LiPF₆ | dibutyltin | 0.08 | 76 | 78 |
| III-14 | EC/VC/DMC/MEC | dimethane- | | | |
| | (27/3/50/20) | sulfonate | | | |
| Comparative | 1.2M LiPF₆ | none | — | 63 | 62 |
| Example | EC/VC/DMC/MEC | | | | |
| III-1 | (29/1/50/20) | | | | |

*1: content (wt %) in nonaqueous electrolytic solution

TABLE 8

| | Composition of | | | | |
|---|---|---|---|---|---|
| | electrolyte salt | | | Discharge | 0° C. discharge |
| | composition of | | | capacity | capacity retention |
| | nonaqueous | | | retention | rate (%) after |
| | electrolytic | Organic | Addition | rate (%) | 85° C. high- |
| | solution (volume | tin | amount | after 0° C. | temperature charge |
| | ratio of solvent) | compound | *1 | 50 cycles | and storage |
| Example | 1.2M LiPF₆ | dibutyltin | 0.08 | 82 | 83 |
| III-15 | EC/FEC/DMC/MEC | dimethane- | | | |
| | (10/20/50/20) | sulfonate | | | |
| Example | 1.2M LiPF₆ | dibutyltin | 0.08 | 80 | 82 |
| III-16 | EC/FEC/DMC/MEC | diacetate | | | |
| | (10/20/50/20) | | | | |
| Example | 1.2M LiPF₆ | dibutyltin | 0.08 | 79 | 80 |
| III-17 | EC/FEC/DMC/MEC | oxide | | | |
| | (10/20/50/20) | | | | |
| Example | 1.2M LiPF₆ | dibutyltin- | 0.08 | 77 | 79 |
| III-18 | EC/FEC/DMC/MEC | O,S-thio- | | | |
| | (10/20/50/20) | glycolate | | | |
| Example | 1.2M LiPF₆ | dibutyltin- | 0.08 | 76 | 77 |
| III-19 | EC/FEC/DMC/MEC | O,S- | | | |
| | (10/20/50/20) | monothio- | | | |
| | | ethylene | | | |
| | | glycolate | | | |
| Example | 1.2M LiPF₆ | dibutyltin | 0.08 | 75 | 75 |
| III-20 | EC/FEC/DMC/MEC | dimethyl- | | | |
| | (10/20/50/20) | mercaptide | | | |
| Example | 1.2M LiPF₆ | dibutyltin- | 0.08 | 74 | 76 |
| III-21 | EC/FEC/DMC/MEC | S,S-bis- | | | |
| | (10/20/50/20) | (methylthio- | | | |
| | | glycolate) | | | |
| Example | 1.2M LiPF₆ | dibutyltin | 0.08 | 73 | 74 |
| III-22 | EC/FEC/DMC/MEC | dimethoxide | | | |
| | (10/20/50/20) | | | | |
| Example | 1.2M LiPF₆ | dibutyltin | 0.08 | 73 | 73 |
| III-23 | EC/FEC/DMC/MEC | bis(acetyl- | | | |
| | (10/20/50/20) | acetonate) | | | |
| Example | 1.2M LiPF₆ | dibutyltin | 0.08 | 80 | 82 |
| III-24 | EC/FEC/DMC/MEC | dimethane- | | | |
| | (5/25/50/20) | sulfonate | | | |
| Example | 1.2M LiPF₆ | dibutyltin | 0.08 | 72 | 71 |
| III-25 | EC/FEC/DMC/MEC | dimethane- | | | |
| | (25/5/50/20) | sulfonate | | | |
| Comparative | 1M LiPF₆ | dibutyltin | 0.5 | 64 | 53 |
| Example | EC/DMC/MEC | bis(acetyl- | | | |
| III-2 | (30/30/40) | acetonate) | | | |

*1: content (wt %) in nonaqueous electrolytic solution

### Example III-26 and Comparative Example III-3

Elemental silicon (negative electrode active, material) was used in place of the negative electrode active material used in Example III-2 and Comparative Example III-1 to produce a negative electrode sheet. Silicon (simple substance): 80% by mass and acetylene black (electroconductive agent): 15% by mass were mixed, and the mixture was added to a solution prepared by dissolving in advance polyvinylidene fluoride (binder): 5% by mass in 1-methyl-2-pyrrolidone and mixed to prepare a negative electrode mixture paste. Coin-type batteries were produced in the same manners as in Example III-2 and Comparative Example III-1 to evaluate the batteries, except that the above negative electrode mixture paste was coated on a copper foil (collector), dried and subjected to pressure treatment and that it was punched into a prescribed size to produce a negative electrode sheet. The results thereof are shown in Table 9.

TABLE 9

| | Composition of | | | | |
|---|---|---|---|---|---|
| | electrolyte salt | | | Discharge | 0° C. discharge |
| | composition of | | | capacity | capacity retention |
| | nonaqueous | | | retention | rate (%) after |
| | electrolytic | Organic | Addition | rate (%) | 85° C. high- |
| | solution (volume | tin | amount | after 0° C. | temperature charge |
| | ratio of solvent) | compound | *1 | 50 cycles | and storage |
| Example | 1.2M LiPF₆ | dibutyltin | 0.08 | 67 | 65 |
| III-26 | EC/VC/DMC/MEC | dimethane- | | | |
| | (29/1/50/20) | sulfonate | | | |
| Comparative | 1.2M LiPF₆ | none | — | 45 | 41 |
| Example | EC/VC/DMC/MEC | | | | |
| III-3 | (29/1/50/20) | | | | |

*1: content (wt %) in nonaqueous electrolytic solution

### Example III-27 and Comparative Example III-4

LiFePO₄ (positive electrode active material) coated with amorphous carbon was used in place of the positive electrode active material used in Example III-2 and Comparative Example III-1 to produce a positive electrode sheet. LiFePO₄ coated with amorphous carbon: 90% by mass and acetylene black (electroconductive agent): 5% by mass were mixed, and the mixture was added to a solution prepared by dissolving in advance polyvinylidene fluoride (binder): 5% by mass in 1-methyl-2-pyrrolidone and mixed to preparer a positive electrode mixture paste. Coin-type batteries were produced in the same manners as in Example III-2, Example III-9 and Comparative Example III-1 to evaluate the batteries, except that the above positive electrode mixture paste was coated on an aluminum foil (collector), dried and subjected to pressure treatment, followed by punching it into a prescribed size to produce a positive electrode sheet and that controlled were a final charging voltage to 3.6 V and a final discharging voltage to 2.0 V in evaluating the batteries. The results thereof are shown in Table 10.

TABLE 10

| | Composition of | | | | |
|---|---|---|---|---|---|
| | electrolyte salt | | | Discharge | 0° C. discharge |
| | composition of | | | capacity | capacity retention |
| | nonaqueous | | | retention | rate (%) after |
| | electrolytic | Organic | Addition | rate (%) | 85° C. high- |
| | solution (volume | tin | amount | after 0° C. | temperature charge |
| | ratio of solvent) | compound | *1 | 50 cycles | and storage |
| Example | 1.2M LiPF₆ | dibutyltin | 0.08 | 79 | 76 |
| III-27 | EC/VC/DMC/MEC | dimethane- | | | |
| | (29/1/50/20) | sulfonate | | | |
| Comparative | 1.2M LiPF₆ | none | — | 65 | 60 |
| Example | EC/VC/DMC/MEC | | | | |
| III-4 | (29/1/50/20) | | | | |

*1: content (wt %) in nonaqueous electrolytic solution

All of the lithium secondary batteries produced in Examples III-1 to III-14 were notably improved in electrochemical characteristics in a broad temperature range as compared with the lithium secondary battery produced in Comparative Example III-1 in which the organic tin compound was not added in the nonaqueous electrolytic solution of the present invention.

Also, all of the lithium secondary batteries produced in Examples III-15 to III-25 were notably improved in electrochemical characteristics in a broad temperature range as compared with the lithium secondary battery produced in Comparative Example III-2 using the nonaqueous electrolytic solution prepared by adding only dibutyltin bis(acetyl acetate) which was an organic tin compound described in Example I-13 of the patent document 1. It became clear from the above matters that the effects of the present invention were effects peculiar to a case in which in the nonaqueous electrolytic solution prepared by dissolving the electrolyte salt in the nonaqueous solvent, cyclic carbonate and linear ester were contained, in which the cyclic carbonate contained at least cyclic carbonate having a fluorine atom or a carbon-carbon double bond and in which 0.001 to 5% by mass of the specific organic tin compound of the present invention was contained.

Also, from comparisons of Example III-26 with Comparative Example III-3, and Example III-27 with Comparative Example III-4, the same effect is observed as well in a case in which silicon (simple substance) was used for the negative electrode and a case in which lithium-containing olivine-type iron phosphate was used for the positive electrode. Accordingly, it is apparent that the effects of the present invention are not effects depending on the specific positive electrode and negative electrode.

Further, the nonaqueous electrolytic solutions of the present invention have as well an effect of improving discharging properties in a broad temperature range in the lithium primary batteries.

### INDUSTRIAL APPLICABILITY

Use of the nonaqueous electrolytic solutions of the present invention makes it possible to obtain electrochemical elements which are excellent in electrochemical characteristics in a broad temperature range. In particular, when they are used as nonaqueous electrolytic solutions for electrochemical elements loaded in hybrid electric vehicles, plug-in hybrid electric vehicles, battery electric vehicles and the like, electrochemical elements which are less liable to be reduced in electrochemical characteristics in a broad temperature range can be obtained.

1. A nonaqueous electrolytic solution prepared by dissolving an electrolyte salt in a nonaqueous solvent, which comprises at least one organic tin compound represented by any one of the following Formulas (I) to (IV) in an amount of 0.001 to 5% by mass of the nonaqueous electrolytic solution:
[Formula 1]
SnR¹R²R³R⁴ (I)
(wherein R¹ represents an alkyl group having 1 to 8 carbon atoms, an alkenyl group having 2 to 8 carbon atoms or an alkynyl group having 2 to 8 carbon atoms; R² to R⁴ each represent independently an alkyl group having 1 to 8 carbon atoms, an alkenyl group having 2 to 8 carbon atoms, an alkynyl group having 2 to 8 carbon atoms or an aryl group having 6 to 12 carbon atoms; and hydrogen atoms of R¹ to R⁴ may be substituted with fluorine atoms); 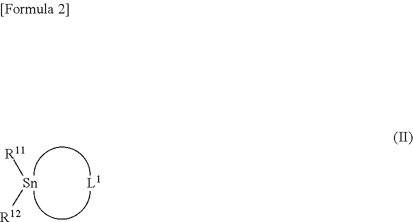
(wherein R¹¹ and R¹² each represent independently an alkyl group having 1 to 8 carbon atoms, an alkenyl group having 2 to 8 carbon atoms, an alkynyl group having 2 to 8 carbon atoms or an aryl group having 6 to 12 carbon atoms; L¹ represents an alkylene group having 2 to 10 carbon atoms or an alkenylene group having 4 to 10 carbon atoms; R¹¹ and R¹² may bond to each other to form a ring; and hydrogen atoms of R¹¹, R¹² and L¹ may be substituted with fluorine atoms); 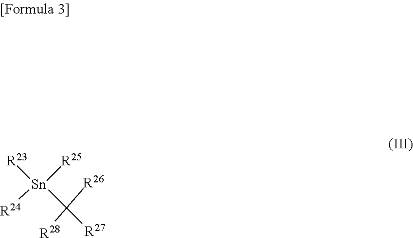
(wherein R²³ to R²⁵ each represent independently an alkyl group having 1 to 8 carbon atoms, a cycloalkyl group having 3 to 8 carbon atoms, an alkenyl group having 2 to 8 carbon atoms, an alkynyl group having 2 to 8 carbon atoms or an aryl group having 6 to 12 carbon atoms; R²⁶ and R²⁷ each represent independently an alkyl group having 1 to 6 carbon atoms, an alkenyl group having 2 to 6 carbon atoms or an alkynyl group having 2 to 6 carbon atoms; R²⁶ and R²⁷ may bond to each other to form a ring; R²⁸ represents a hydrogen atom, an alkyl group having 1 to 6 carbon atoms, an alkenyl group having 2 to 6 carbon atoms or an alkynyl group having 2 to 6 carbon atoms; and hydrogen atoms of R²³ to R²⁸ may be substituted with fluorine atoms); 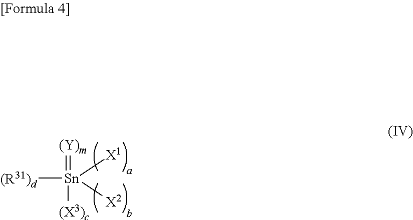
(wherein X¹, X² and X³ each represent independently the following substituents containing an oxygen atom or a sulfur atom:
—OSO₂R³² —OC(O)R³² —OR³² —SR³² —S-L³-OC(O)PR³² —OC(R³²)═CHC(O)R³² —OC(R³³)═CHC(O)R³² [Formula 5]
X¹ and X² may bond to each other to form the following substituents:
—O-L³-O— —S-L³-S— —S-L³-O— —S-L³-C(O)O— [Formula 6]
R³¹ represents an alkyl group having 1 to 8 carbon atoms, an alkenyl group having 2 to 8 carbon atoms, an alkynyl group having 2 to 8 carbon atoms or an aryl group having 6 to 12 carbon atoms; R³² and R³³ represent an alkyl group having 1 to 8 carbon atoms or an aryl group having 6 to 12 carbon atoms; Y represents an oxygen atom or a sulfur atom; L represents an alkylene group having 1 to 8 carbon atoms which may have an ether bond or a carbon-carbon unsaturated bond; hydrogen atoms of R³¹, R³², R³³ and L³ may be substituted with fluorine atoms; a, b and c represent 0 or 1; d represents an integer of 1 to 3, and m represents 0 or 1; when m is 0, a+b+c+d=4; and when m is 1, a=b=c=0, and d=2).

2. The nonaqueous electrolytic solution according to claim 1, wherein the nonaqueous solvent contains cyclic carbonate and linear ester.

3. The nonaqueous electrolytic solution according to claim 2, wherein the linear ester is linear carbonate.

4. The nonaqueous electrolytic solution according to claim 3, wherein the linear carbonate contains at least both of symmetric linear carbonate and asymmetric linear carbonate, and a content of the symmetric, linear carbonate is larger than that of the asymmetric linear carbonate.

5. The nonaqueous electrolytic solution according to claim 4, wherein a content of the symmetric linear carbonate in the nonaqueous solvent is 40 to 60% by volume.

6. The nonaqueous electrolytic solution according to claim 2, wherein at least two or more kinds of the cyclic carbonates are contained.

7. The nonaqueous electrolytic solution according to claim 6, wherein the cyclic carbonate contains at least cyclic carbonate having a fluorine atom or a carbon-carbon double bond.

8. The nonaqueous electrolytic solution according to claim 7, wherein the cyclic carbonate having a fluorine atom is 4-fluoro-1,3-dioxolane-2-one or 4,5-difluoro-1,3-dioxolane-2-one, and the cyclic carbonate having a carbon-carbon double bond is vinylene carbonate and/or vinylethylene carbonate.

9. An electrochemical element comprising a positive electrode, a negative electrode and a nonaqueous electrolytic solution prepared by dissolving an electrolyte salt in a nonaqueous solvent, wherein the above nonaqueous electrolytic solution is the nonaqueous electrolytic solution according to claim 1.
